(19) United States
(12) Patent Application Publication
(10) Pub. No.: US 2017/0060460 A1
(43) Pub. Date: Mar. 2, 2017

(54) MEMORY CONTROLLER

(71) Applicant: MegaChips Corporation, Osaka-shi (JP)

(72) Inventors: Takahiko Sugahara, Osaka (JP); Hiromu Yutani, Osaka (JP); Hajime Yoshimura, Osaka (JP)

(73) Assignee: MegaChips Corporation, Osaka-shi (JP)

(21) Appl. No.: 15/242,713

(22) Filed: Aug. 22, 2016

(30) Foreign Application Priority Data
Aug. 31, 2015 (JP) 2015-171270
Aug. 31, 2015 (JP) 2015-171271

(51) Int. Cl. G06F 3/06; G06F 12/14

(52) U.S. Cl. CPC G06F 3/0623; G06F 3/0658; G06F 3/0659; G06F 3/0679; G06F 12/14; G06F 2212/1052; G06F 2212/214

(57) ABSTRACT

An object of the present invention is to provide a technique that makes it difficult to fabricate an illegal duplicate of a semiconductor storage apparatus. In a memory controller, an address acquisition unit acquires a latency-related designated address. The latency-related designated address is an address in the semiconductor memory storing data to be transmitted with the minimum latency upon reception of a read command, and is identical with an address held by a host. A pre-acquisition unit reads the data for the latency-related designated address from the semiconductor memory and stores it in the buffer. A comparator compares the address included in the read command to the latency-related designated address. Depending on the result of the comparison by the comparator, a transmission control unit transmits the data stored in the buffer to the host at the time point of completion of a minimum latency.

### BACKGROUND

Technical Field

The present invention relates to a memory controller that accesses a semiconductor memory in response to a request by a host.

Description of the Background Art

A semiconductor storage apparatus includes a memory controller and a semiconductor memory such as a NAND flash memory. When the memory controller receives from a host an instruction for reading data, an instruction for writing data or other instructions, the memory controller controls access to the semiconductor memory depending on the instruction from the host.

Traditionally, various measures have been taken to ensure security of data such as content stored in the semiconductor memory, such as authentication or encryption of data. If authentication is employed, the host and memory controller check each other's validity and then read data stored in the semiconductor memory. If encryption is employed, the memory controller encrypts data read from the semiconductor memory and transmits it to the host. Alternatively, the memory controller encrypts data before writing it to the semiconductor memory, and decrypts encrypted data read from the semiconductor memory before transmitting it to the host.

Patent Document 1 discloses a semiconductor memory apparatus that encrypts data that that it has read from memory cells before outputting the data to the outside. When the semiconductor memory apparatus receives a read command from the outside, it reads data for the address designated by the read command from the associated memory cells. The semiconductor memory apparatus encrypts the data that has been read by using an incorporated logic circuit to XOR the data that has been read and the address designated by the read command. The semiconductor memory apparatus outputs the encrypted data as a response to the read command.

Patent Document 1 JP Hei7(1995)-219852 A

### SUMMARY

In implementations where encryption is employed as in the semiconductor memory apparatus of Patent Document 1, a cryptographic key may be stolen by a malicious third party. If a cryptographic key is stolen, the security of the data stored in the semiconductor memory will be nullified. In implementations where security is ensured by authentication, a password used for authentication may be stolen, in which case, again, the security of the data stored in the semiconductor memory will be nullified.

If a third party manages to steal a cryptographic key or password used to access the semiconductor storage apparatus, the third party will be allowed to read all of the data stored in the semiconductor memory, which will enable the third party to easily duplicate the data stored in the semiconductor memory. As a result, illegal duplicates of the semiconductor storage apparatus may be circulated on the market.

An object of the present invention is to provide a technique that makes it difficult to fabricate an illegal duplicate of a semiconductor storage apparatus.

A memory controller according to the present disclosure accesses a semiconductor memory in response to a request from a host. The memory controller includes a command decoder and an access control unit. The command decoder extracts an address in a semiconductor memory from a read command received from the host. The access control unit configured to transmit, to the host, data in the semiconductor memory associated with the address at a time point decided based on a predetermined fixed latency period.

An illegal duplicate memory controller cannot operate in the same manner as the memory controller according to the present disclosure. This makes it difficult to fabricate an illegal duplicate of a semiconductor storage apparatus including the memory controller according to the present disclosure.

Preferably, the fixed latency period is a minimum latency with which the memory controller can respond to the read command. The memory controller includes an address acquisition unit. The acquisition unit acquires a latency-related designated address, which is an address in the semiconductor memory storing data to be transmitted with the minimum latency in response to the read command, and is identical with an address held by the host. The access control unit includes a pre-acquisition unit, a comparator, and a transmission control unit. The pre-acquisition unit reads the data for the latency-related designated address from the semiconductor memory and stores it in a buffer. The comparator compares the address extracted from the read command to the latency-related designated address acquired by the address acquisition unit. Based on a result of the comparison by the comparator, the transmission control unit transmits the data stored in the buffer to the host at a time point at which the minimum latency ends.

Since a third party cannot identify the latency-related designated address, the memory controller in an illegal duplicate semiconductor storage apparatus fabricated by the third party cannot transmit the data for the latency-related designated address to the host with the minimum latency. That is, the memory controller of the illegal duplicate semiconductor storage apparatus cannot operate in the same manner as the memory controller according to the present invention. This makes it difficult to fabricate an illegal duplicate of the semiconductor storage apparatus.

Preferably, the memory controller further includes a latency acquisition unit. The latency acquisition unit acquires the fixed latency period, which is identical with a latency period held by the host. The access control unit includes a read control unit, and a transmission control unit. The read control unit instructs the semiconductor memory to read the data for the address extracted from the read command. The latency acquisition unit acquires the fixed latency period. The transmission control unit decides on a transmission time point at which transmission of the data for the address is initiated based on the fixed latency period such that an interval between a time point at which the read command is received and the transmission time point is longer than a time required to read the data for the address from the semiconductor memory, and transmits the data for the address to the host at the transmission time point that has been decided on.

The transmission control unit transmits the data for the address included in the read command at the transmission time point decided based on the fixed latency period. This makes it difficult to fabricate an illegal duplicate of a semiconductor storage apparatus including the memory controller according to the present invention. Further, the memory controller according to the present invention conceals busy signals transmitted until the initiation of transmission of the data for an address included in a read command. Thus, when the data for the address included in the read command is being transmitted from the memory controller to the host, it is difficult for a third party to identify this data.

### BRIEF DESCRIPTION OF THE DRAWINGS

FIG. 1 is a functional block diagram of a memory system according to a first embodiment of the present invention.

FIG. 2 is a functional block diagram of the host shown in FIG. 1.

FIG. 3 is a functional block diagram of the semiconductor storage apparatus shown in FIG. 1.

FIG. 4 is a functional block diagram of the semiconductor memory shown in FIG. 1.

FIG. 5 is a sequence diagram illustrating the operations performed by the host and memory controller shown in FIG. 1 when generating a latency-related designated address.

FIG. 6 is a sequence diagram illustrating the operations performed by the host and memory controller shown in FIG. 1 when the host is transmitting a read command including a normal address.

FIG. 7 is a sequence diagram illustrating the operations performed by the host and memory controller shown in FIG. 1 when the host is transmitting a read command including a latency-related designated address.

FIG. 8 illustrates timing in which data is transmitted when the memory controller shown in FIG. 1 is performing the fixed latency process.

FIG. 9 illustrates timing in which data is transmitted when the memory controller shown in FIG. 1 is performing the variable latency process.

FIG. 10 illustrates another example of timing in which data is transmitted when the memory controller shown in FIG. 1 is performing the fixed latency process.

FIG. 11 illustrates yet another example of timing in which data is transmitted when the memory controller shown in FIG. 1 is performing the fixed latency process.

FIG. 12 is a functional block diagram of a memory system according to a second embodiment of the present invention.

FIG. 13 is a functional block diagram of the host shown in FIG. 12.

FIG. 14 is a functional block diagram of the semiconductor storage apparatus shown in FIG. 12.

FIG. 15 is a functional block diagram of the semiconductor memory shown in FIG. 12.

FIG. 16 is a sequence diagram illustrating the operations performed by the host and memory controller to decide the fixed latency period shown in FIG. 13.

FIG. 17 is a sequence diagram illustrating the operations of the host and memory controller shown in FIG. 12 performed when the host is transmitting a read command including a normal address.

FIG. 18 illustrates timing in which the read data is transmitted when the memory controller shown in FIG. 12 performs the variable latency process.

FIG. 19 is a sequence diagram illustrating the operations of the host and memory controller performed when the host shown in FIG. 12 transmits a read command including the specified address.

FIG. 20 illustrates timing in which the read data is transmitted when the memory controller shown in FIG. 12 performs the fixed latency process.

FIG. 21 illustrates timing in which the memory controller of a duplicate transmits read data.

FIG. 22 illustrates another example of timing in which the read data is transmitted when the memory controller shown in FIG. 12 performs the fixed latency process.

### DETAILED DESCRIPTION OF THE PREFERRED EMBODIMENTS

Embodiments of the present invention will now be described in detail with reference to the drawings. The same or corresponding components in the drawings are labeled with the same characters, and their description will not be repeated.

### First Embodiment

### 1. Configuration of Memory System

{1.1 Overall Configuration}

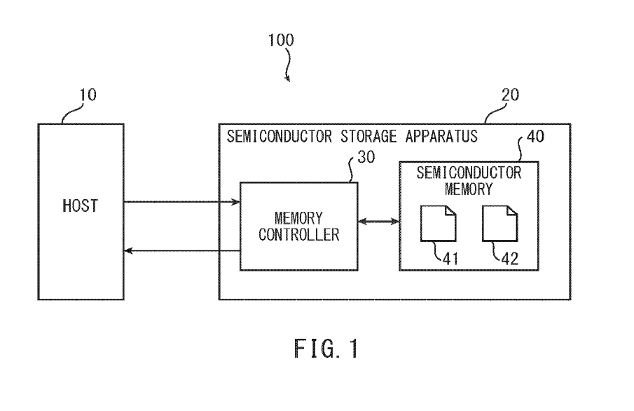

FIG. 1 is a functional block diagram of a memory system 100 according to a first embodiment of the present invention. As shown in FIG. 1, the memory system 100 includes a host 10 and a semiconductor storage apparatus 20. The semiconductor storage apparatus 20 includes a memory controller 30 and a semiconductor memory 40.

In response to a request from the host 10, the memory controller 30 accesses the semiconductor memory 40.

The semiconductor memory 40 is non-volatile, and may be a NAND flash memory, for example. The semiconductor memory 40 stores a program 41 and content data 42 that can be used by the host 10. The program 41 is a program for using the content data 42.

{1.2 Configuration of Host 10}

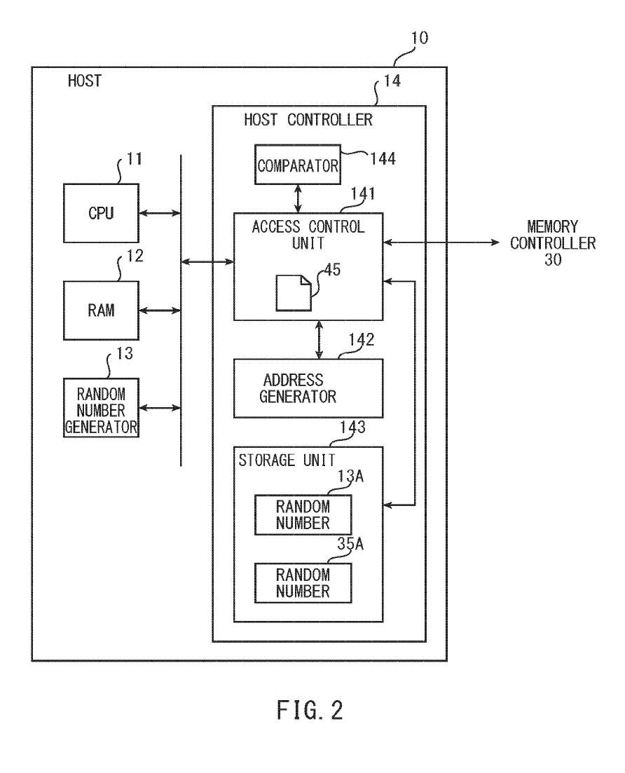

FIG. 2 is a functional block diagram of the host 10 shown in FIG. 1. As shown in FIG. 2, the host 10 includes a central processing unit (CPU) 11, a random access memory (RAM) 12, a random number generator 13, and a host controller 14. The CPU 11, RAM 12, random number generator 13 and host controller 14 are connected via buses.

The CPU 11 executes a program loaded into the RAM 12 to control the operation of the host 10. The RAM 12 is the main memory of the host 10.

The random number generator 13 generates genuinely random numbers. The random number generator 13 generates a random number 13A used to generate a latency-related designated address 45. The latency-related designated address 45 is the one of the addresses in the semiconductor memory 40 that stores data to be transmitted with a minimum latency after the memory controller 30 receives a read command. The latency-related designated address 45 is held by the access control unit 141. The latency-related designated address 45 will be described in detail further below.

In response to an instruction by the CPU 11, the host controller 14 controls access by the host 10 to the semiconductor storage apparatus 20. The host controller 14 includes an access control unit 141, an address generator 142, a storage unit 143, and a comparator 144.

The access control unit 141 transmits to the memory controller 30 a command that is based on the instruction by the CPU 11, and receives a response to the transmitted command. The comparator 144 compares the address included in the read command to the latency-related designated address 45.

The address generator 142 generates the latency-related designated address 45 from the random number 13A and random number 35A stored in the storage unit 143. The random number 35A is generated by the memory controller 30, as described below.

The storage unit 143 may be a set of registers, for example, and stores the random number 13A generated by the random number generator 13 and the random number 35A generated by the memory controller 30.

{1.3 Configuration of Memory Controller 30}

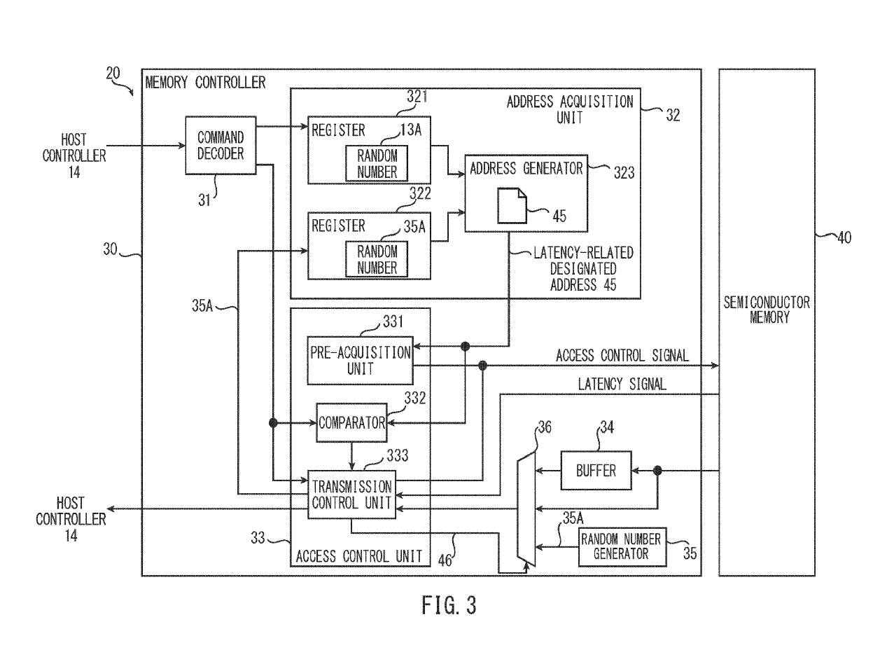

FIG. 3 is a functional block diagram of the semiconductor storage apparatus 20 shown in FIG. 1. As shown in FIG. 3, the memory controller 30 includes a command decoder 31, an address acquisition unit 32, an access control unit 33, a buffer 34, a random number generator 35, and a selector 36.

The memory controller 30 is connected to the host controller 14. In FIG. 3, the interface circuit in the memory controller 30 connecting to the host 10 (i.e. host I/F) and the interface circuit connecting to the semiconductor memory 40 (i.e. memory I/F) are not shown.

The command decoder 31 receives a command transmitted by the host controller 14 and decodes the received command. For example, if the command decoder 31 receives a read command, it decodes the read command and extracts the address from the read command. The command decoder 31 provides the read instruction and the extracted address to the access control unit 33. The address included in the read command will be hereinafter referred to as “read address”.

The address acquisition unit 32 acquires the latency-related designated address 45. The address acquisition unit 32 includes a register 321, a register 322 and an address generator 323.

The register 321 stores the random number 13A generated by the random number generator 13 (see FIG. 2). The register 322 stores the random number 35A, which is generated by the random number generator 35. The address generator 323 generates the latency-related designated address 45 from the random number 13A stored in the register 321 and the random number 35A stored in the register 322. The address generator 323 and the address generator 142 of the host 10 generate the same latency-related designated address 45.

In response to the read command from the host 10, the access control unit 33 transmits data read from the semiconductor memory 40 to the host controller 14. The access control unit 33 includes a pre-acquisition unit 331, a comparator 332 and a transmission control unit 333.

The pre-acquisition unit 331 instructs the semiconductor memory 40 to read data for the latency-related designated address 45 acquired by the address acquisition unit 32, and stores, in the buffer 34, the data for the latency-related designated address 45 read from the semiconductor memory 40.

The comparator 332 compares the read address to the latency-related designated address 45 generated by the address acquisition unit 32. The comparator 332 provides the result of this comparison to the transmission control unit 333.

Depending on the result of the comparison by the comparator 332, the transmission control unit 333 reads the data for the read address from the semiconductor memory 40 or buffer 34 and transmits it to the host controller 14. More specifically, if the read address matches the latency-related designated address 45, the transmission control unit 333 provides to the host 10 the data stored in the buffer 34 as a response to the read command at a time point that represents a latency of zero. If the read address does not match the latency-related designated address 45, the transmission control unit 333 instructs the semiconductor memory 40 to read data for the read address. The transmission control unit 333 provides to the host 10 the data read from the semiconductor memory 40 as a response to the read command.

In response to an instruction by the pre-acquisition unit 331, the buffer 34 stores data read from the semiconductor memory 40. The data stored in the buffer 34 is the data for the latency-related designated address 45 in the semiconductor memory 40.

The random number generator 35 generates the random number 35A. The random number 35A is used to decide the latency-related designated address 45. The random number generator 35 generates genuinely random numbers. Accordingly, the random number 35A generated by the random number generator 35 is different from the random number 13A generated by the random number generator 13.

The selector 36 provides to the transmission control unit 333 the data stored in the buffer 34, the random number 35A generated by the random number generator 35, or data that was read from the semiconductor memory 40 in response to an instruction from the transmission control unit 333. The operation of the selector 36 is decided on by the transmission control unit 333.

{1.4 Configuration of Semiconductor Memory 40}

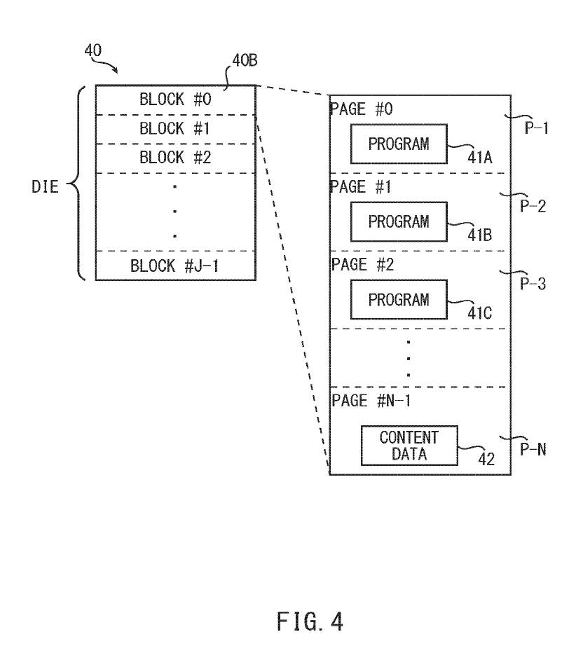

FIG. 4 is a functional block diagram of the semiconductor memory 40 shown in FIG. 1. As shown in FIG. 4, the semiconductor memory 40 is formed by one die. The includes J blocks. Each block includes N pages. J and N are natural numbers equal to or greater than 1. A block is the unit of data for deletion in the semiconductor memory 40. A page is the unit of data for reading and writing in the semiconductor memory 40.

In the semiconductor memory 40, the block 40B includes pages P-1 to P-N. The programs 41A to 41C are stored in pages P-1 to P-3, respectively. The programs 41A to 41C constitute the program 41 shown in FIG. 1. The programs 41A to 41C are generated by dividing the program 41 into sub-programs (i.e. programs 41A to 41C) with a data size that allows storage in a page. Accordingly, the programs 41A to 41C cannot be executed separately. The content data 42 is stored in page P-N.

### 2. Operation of Memory System

The operation of the memory system 100 will be described below. No description of the process of converting a logical address to a physical address performed by the memory controller 30 will be given.

{2.1 Summary}

When the host 10 is powered on, a latency-related designated address 45 is generated by the host 10 and memory controller 30. Since the latency-related designated address 45 is generated from a random number 13A and a random number 35A, it has a random value. Further, the latency-related designated address 45 is updated after the memory controller 30 transmits data for the latency-related designated address 45 to the host 10.

When the memory controller 30 receives a read command from the host 10, it compares the read address to the latency-related designated address 45. Based on the result of this comparison, the memory controller 30 performs a fixed latency process or a variable latency process.

The variable latency process is a normal read process, and is performed when the read address is an address other than the latency-related designated address 45. The memory controller 30 reads data for the read address from the semiconductor memory 40, and transmits the read data to the host 10.

When the variable latency process is performed, there is a latency equal to or longer than a certain time period. A latency is a time period from a time at which the memory controller 30 completes reception of a read command to a time at which it provides data for the read address to the host 10. The time period required to read data from the semiconductor memory 40 varies depending on the performance of the semiconductor memory 40 and the read address, for example.

The fixed latency process is performed when the read address matches the latency-related designated address 45. The fixed latency process outputs the data stored in the buffer 34 as a response to the read command. As described in detail further below, performing the fixed latency process achieves a latency of zero.

Thus, when the memory controller 30 receives a read command including the latency-related designated address 45, it transmits the data for the latency-related designated address 45 to the host 10 at a time point that represents a latency of zero. Since the latency-related designated address 45 has a random value, a third party cannot identify the latency-related designated address 45. Thus, even if the third party fabricates an illegal duplicate of the semiconductor storage apparatus 20, the memory controller in the duplicate, when receiving a read command including the latency-related designated address 45, cannot transmit the data for the latency-related designated address 45 to the host 10 at a time point that represents a latency of zero. Since the memory controller in the duplicate cannot operate in the same manner as the memory controller 30, it is difficult to fabricate an illegal duplicate of the semiconductor storage apparatus 20. An illegal duplicate of the semiconductor storage apparatus 20 will be hereinafter simply referred to as “duplicate”.

{2.2 Decision on Latency-Related Designated address 45}

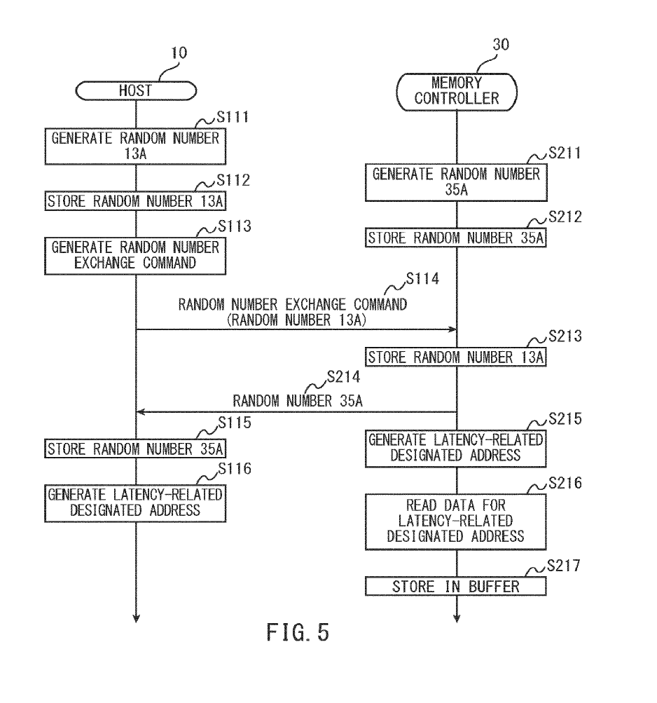

FIG. 5 is a sequence diagram illustrating the operations performed by the host 10 and memory controller 30 when deciding on a latency-related designated address 45. The sequence diagram shown in FIG. 5 starts when the host 10 is powered on.

First, the operation of the host 10 will be described. When the host 10 is powered on, the CPU 11 instructs the random number generator 13 to generate a random number 13A. In response to the instruction by the CPU 11, the random number generator 13 generates a random number 13A (step S111). The generated random number 13A is provided to the CPU 11 and host controller 14.

The access control unit 141 in the host controller 14 stores the random number 13A from the random number generator 13 in the storage unit 143 (step S112).

The CPU 11 generates a random number exchange command (step S113). The CPU 11 attaches the random number 13A from the random number generator 13 to the random number exchange command. The random number exchange command is a command for transmitting the random number 13A to the memory controller 30 and requesting transmission of a random number 35A generated by the memory controller 30.

The access control unit 141 receives from the CPU 11 the random number exchange command with the random number 13A attached to it. The host controller 14 transmits the received random number exchange command to the memory controller 30 (step S114). The access control unit 141 waits until it receives a response to the random number exchange command.

Next, the operation of the memory controller 30 will be described. The memory controller 30 starts up following the powering-on of the host 10. The random number generator 35 in the memory controller 30 generates a random number 35A (step S211). The random number generators 13 and 35 generate genuinely random numbers. As such, the random numbers 13A and 35A generated directly after the memory system 100 starts up have different values.

The random number 35A is stored in the register 322 (step S212). More specifically, directly after the memory controller 30 starts up, the transmission control unit 333 provides to the selector 36 a select signal 46 for instructing the selector 36 to output the random number 35A. In response to the select signal 46 from the transmission control unit 333, the selector 36 switches to input from the random number generator 35. Thus, the transmission control unit 333 receives the random number 35A from the random number generator 35. The transmission control unit 333 provides the received random number 35A to the register 322. The register 322 stores the random number 35A received from the transmission control unit 333.

The memory controller 30 receives the random number exchange command transmitted by the host controller 14 at step S114. The memory controller 30 stores in the register 321 the random number 13A attached to the received random number exchange command (step S213). More specifically, the command decoder 31 decodes the received random number exchange command and determines that the host 10 is requesting exchange of random numbers. The command decoder 31 extracts the random number 13A attached to the random number exchange command and provides it to the register 321. The register 321 stores the random number 13A received from the command decoder 31.

The memory controller 30 transmits to the host 10 the random number 35A generated by the random number generator 35 as a response to the received random number exchange command (step S214). More specifically, the command decoder 31 informs the transmission control unit 333 that it has received a random number exchange command. In response to the informing by the command decoder 31, the transmission control unit 333 transmits the random number 35A received from the random number generator 35 as a response to the random number exchange command.

The address acquisition unit 32 generates a latency-related designated address 45 (step S215). More specifically, the address generator 323 uses a predetermined algorithm to generate the latency-related designated address 45 from the random number 13A stored in the register 321 and the random number 35A stored in the register 322. The algorithm may be, for example, but not limited to, a pseudo-random number generation algorithm, hash-based message authentication code (HMAC), etc.

The memory controller 30 reads data for the latency-related designated address 45 from the semiconductor memory 40 (step S216). More specifically, the address generator 323 provides the generated latency-related designated address 45 to the pre-acquisition unit 331. The pre-acquisition unit 331 provides the latency-related designated address 45 to the semiconductor memory 40 and instructs the semiconductor memory 40 to read data at the latency-related designated address 45. In response to the instruction by the pre-acquisition unit 331, the semiconductor memory 40 reads the data at the latency-related designated address 45. The data for the latency-related designated address 45 read from the semiconductor memory 40 is stored in the buffer 34 (step S217). With this, the process performed by the memory controller 30 upon startup of the memory system 100 ends.

The access control unit 141 in the host 10 receives the random number 35A and recognizes it as a response to the random number exchange command. The access control unit 141 stores the received random number 35A in the storage unit 143 (step S115).

The address generator 142 generates a latency-related designated address 45 from the random numbers 13A and 35A stored in the storage unit 143 (step S116). The algorithm used by the address generator 142 to generate the latency-related designated address 45 is the same algorithm used by the address generator 323 in the memory controller 30. As a result, the latency-related designated address 45 generated by the address generator 142 is the same as the latency-related designated address 45 generated by the address generator 323 in the memory controller 30.

{2.3 Variable Latency Process}

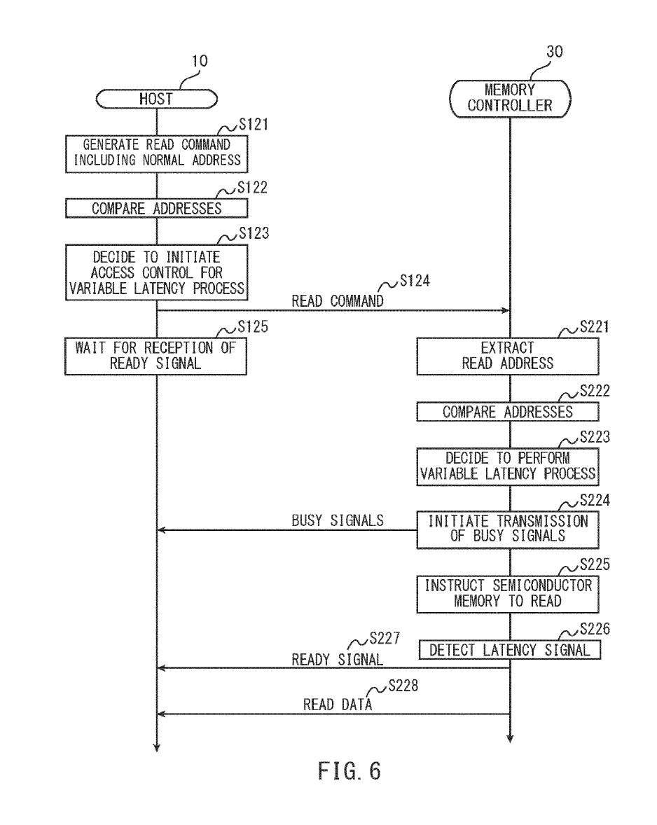

FIG. 6 is a sequence diagram illustrating the operations performed by the host 10 and memory controller 30 when the host 10 is transmitting a read command including an address other than the latency-related designated address 45. An address other than the latency-related designated address 45 will be hereinafter referred to as “normal address”.

The host 10 performs steps S121 to S124 to transmit a read command including a normal address to the memory controller 30. The CPU 11 in the host 10 generates a read command and attaches a read address to the generated read command. In the example shown in FIG. 6, the read address attached is a normal address. Thus, a read command including a normal address is generated (step S121).

The CPU 11 provides the generated read command to the access control unit 141. The comparator 144 receives the latency-related designated address 45 and the read address included in the read command from the access control unit 141 and compares the read address to the latency-related designated address 45 (step S122).

Since the read address attached to the read command in the example shown in FIG. 6 is a normal address, the comparator 144 determines that the two addresses being compared do not match and informs the access control unit 141 of the result of the comparison. Based on the output of the comparator 144, the access control unit 141 determines that, if the read command is transmitted to the memory controller 30, the memory controller 30 will perform the variable latency process. The access control unit 141 decides to initiate access control for the variable latency process (step S123).

The access control unit 141 transmits the read command received from the CPU 11 to the memory controller 30 (step S314). The access control unit 141 initiates access control for the variable latency process. More specifically, the access control unit 141 waits until it receives a ready signal from the memory controller 30 (step S125).

The command decoder 31 in the memory controller 30 receives the read command transmitted by the host 10 at step S124. The command decoder 31 decodes the read command received. As such, the command decoder 31 determines that the host 10 is instructing the memory controller 30 to read, and extracts the read address from the read command received (step S221).

The command decoder 31 provides the result of the decoding (i.e. read instruction and extracted read address) to the comparator 332 and transmission control unit 333. The comparator 332 compares the read address received from the command decoder 31 to the latency-related designated address 45 (step S222). Since the read address attached to the read command in the example shown in FIG. 6 is a normal address, the comparator 332 informs the transmission control unit 333 that the read address does not match the latency-related designated address 45. Based on the output of the comparator 332, the transmission control unit 333 decides to perform the variable latency process to read the data for the read address from the semiconductor memory 40 (step S223). The variable latency process includes steps S224 to S228.

The transmission control unit 333 initiates transmission of busy signals to the host 10 (step S224). Further, the transmission control unit 333 provides to the semiconductor memory 40 an access control signal for instructing the memory to read the data at the read address (step S225). The transmission control unit 333 transmits the select signal 46 to the selector 36 to allow the selector 36 to read the data for the read address from the semiconductor memory 40.

The transmission control unit 333 waits until a latency signal is output by the semiconductor memory 40 while continuing to transmit busy signals. The latency signal is a signal for informing that the data for the read address can be read from the semiconductor memory 40. When the transmission control unit 333 detects the latency signal (step S226), it transmits a ready signal to the host 10 (step S227). The transmission control unit 333 reads the data for the read address from the semiconductor memory 40. After transmitting the ready signal, the transmission control unit 333 transmits the data for the read address to the host 10 (step S228).

When the ready signal has been transmitted to the access control unit 141 in the host 10 from the memory controller 30, the access control unit 141 determines that transmission of the data for the read address will be initiated. The access control unit 141 receives data transmitted after the ready signal and regards it as the data for the read address. The access control unit 141 provides the data for the read address to the CPU 11. The CPU 11 executes a process using the data for the read address.

{2.4 Fixed Latency Process}

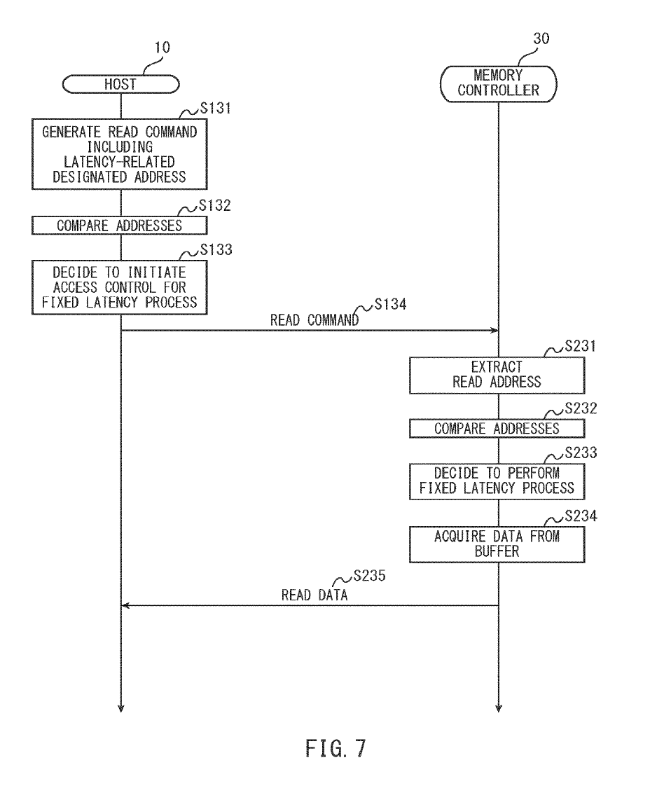

FIG. 7 is a sequence diagram illustrating the operations performed by the host 10 and memory controller 30 when the host 10 is transmitting a read command including the latency-related designated address 45.

As shown in FIG. 7, the host 10 performs steps S131 to S133 to transmit a read command including the latency-related designated address 45 to the memory controller 30. More specifically, the CPU 11 generates a read command and attaches a read address to the generated read command. In the example shown in FIG. 7, the read address attached to the read command is the latency-related designated address 45. Thus, a read command including the latency-related designated address 45 is generated (step S131).

The CPU 11 provides the generated read command to the access control unit 141. The comparator 144 receives the latency-related designated address 45 and the read address included in the read command from the access control unit 141, and compares the read address to the latency-related designated address 45 (step S132).

Since the read address attached to the read command is the latency-related designated address 45 in the example shown in FIG. 7, the comparator 144 determines that the two addresses being compared match, and informs the access control unit 141 of the result of the comparison. Based on the output of the comparator 144, the access control unit 141 determines that, when the read command is transmitted to the memory controller 30, the memory controller 30 will perform the fixed latency process. The access control unit 141 initiates access control for the fixed latency process (step S133). The access control for the fixed latency process will be described further below.

The access control unit 141 transmits the read command received from the CPU 11 to the memory controller 30 (step S134).

When the memory controller 30 receives the read command transmitted by the host 10 at step S134, it performs steps S231 to S235 to transmit the data for the latency-related designated address 45 to the host 10.

More specifically, the command decoder 31 decodes the read command. Based on the result of the decoding, the command decoder 31 determines that the host 10 is instructing the memory controller 30 to read, and extracts the read address from the read command (step S231). The command decoder 31 provides the result of the decoding (i.e. read instruction and extracted read address) to the comparator 332 and transmission control unit 333.

The comparator 332 compares the read address from the command decoder 31 to the latency-related designated address 45 (step S232). In the example shown in FIG. 7, the read address attached to the read command is the latency-related designated address 45. As such, the comparator 332 determines that the two addresses being compared match, and informs the transmission control unit 333 of the result of the comparison. Based on the output of the comparator 332, the transmission control unit 333 decides to perform the fixed latency process (step S233).

The transmission control unit 333 provides to the selector 36 the select signal 46 for instructing the selector 36 to connect to the buffer 34 to read the data for the latency-related designated address 45 stored in the buffer 34 (step S234). The transmission control unit 333 transmits the data for the latency-related designated address 45 that has been read to the host 10 (step S235). The memory controller 30 outputs no busy signal or ready signal from the time at which it receives the read command until the time at which it transmits the data for the latency-related designated address 45. The data for the latency-related designated address 45 is transmitted directly after the memory controller 30 receives the read command. In other words, if the latency-related designated address 45 is included in the read command, the memory controller 30 transmits the data for the latency-related designated address 45 at a time point that represents a latency of zero.

Access control for the fixed latency process performed by the host 10 will be described. As discussed above, when the fixed latency process is being performed, the memory controller 30 transmits no busy signal or ready signal, and transmits the data for the latency-related designated address 45 directly after it receives the read command. As such, during access control for the fixed latency process, the access control unit 141 does not wait until it receives a ready signal. Since the time point at which it finished transmitting the read command is a time point that represents a latency of zero, the access control unit 141 recognizes the data received from the memory controller 30 directly after it transmitted the read command as the data for the latency-related designated address 45.

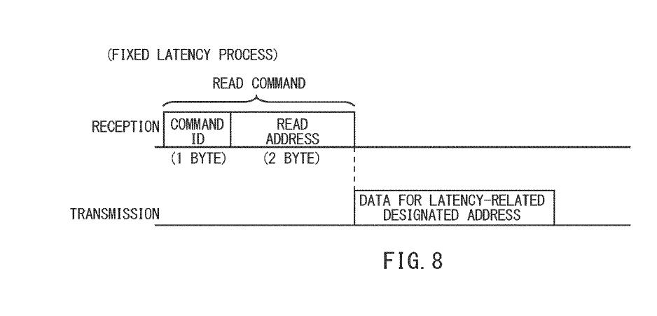

The reasons why it is possible for the memory controller 30 to transmit the data for the latency-related designated address 45 directly after it received the read command in the fixed latency process will be described below. FIG. 8 illustrates timing in which the data for the latency-related designated address 45 is transmitted when the memory controller 30 is performing the fixed latency process. As shown in FIG. 8, the read command includes a command ID with one byte and a read address with two bytes. The command ID is a value uniquely indicating that it is included in a read command. The command decoder 31 receives the read command on a byte-by-byte basis. As such, when the command decoder 31 has received the first byte of the read command, it can determine that the host 10 is instructing it to read data from the semiconductor memory 40. The command decoder 31 provides the read address with two bytes following the command ID to the comparator 332 on a byte-by-byte basis for comparison of addresses.

The comparator 332 compares the read address and the latency-related designated address 45 on a byte-by-byte basis. When the comparator 332 has finished comparing the last byte of the read address, it informs the transmission control unit 333 of the result of the comparison. Based on the result of the comparison, the transmission control unit 333 controls the selector 36 such that the data stored in the buffer 34 can be output. The transmission control unit 333 transmits the data from the buffer 34 (i.e. data for the latency-related designated address 45) to the host 10 without manipulating it. As a result, the memory controller 30 is capable of transmitting the data for the latency-related designated address 45 to the host 10 directly after it receives a read command. In other words, as shown in FIG. 8, the data for the latency-related designated address 45 is transmitted to the host 10 at a time point that represents a latency of zero.

{2.5 Update of Latency-Related Designated Address 45}

When the process shown in FIG. 7 is finished, the latency-related designated address 45 held by the host 10 and memory controller 30 is updated. The procedure for updating the latency-related designated address 45 is the same as the process shown in FIG. 5. An update of the latency-related designated address 45 occurs in the memory controller 30 between the time at which the memory controller 30 transmits the data for the latency-related designated address 45 and the time at which it receives a next read command. An update of the latency-related designated address 45 occurs in the host 10 between the time at which the host receives the data for the latency-related designated address 45 and the time at which it generates the next read command. In other words, the host 10 and memory controller 30 update the latency-related designated address in a predetermined interval beginning at the time at which the process of reading the data for the latency-related designated address 45 is finished.

Referring to FIG. 5, when the latency-related designated address 45 is to be updated, the host 10 generates a new random number that is different from the random number 13A after the process for the read command is finished (step S111). Further, the memory controller 30 generates a new random number that is different from the random number 35A (step S211). The new random number generated by the host 10 and the new random number generated by the memory controller 30 are exchanged between the host 10 and memory controller 30 (steps S114 and S214). The host 10 and memory controller 30 generate a new latency-related designated address 45 based on the two new random numbers (steps S116 and S215). Each time data for a latency-related designated address 45 is transmitted to the host 10, the latency-related designated address 45 is changed in a random manner. Accordingly, a third party cannot learn in advance the address of data that is read at a time point that represents a latency of zero.

{2.6 Difficulty in Fabricating Duplicate of Semiconductor Storage Apparatus 20}

Next, the reasons why it is difficult for a third party to fabricate a duplicate if the memory controller 30 transmits data for a latency-related designated address 45 at a time point that represents a latency of zero will be described.

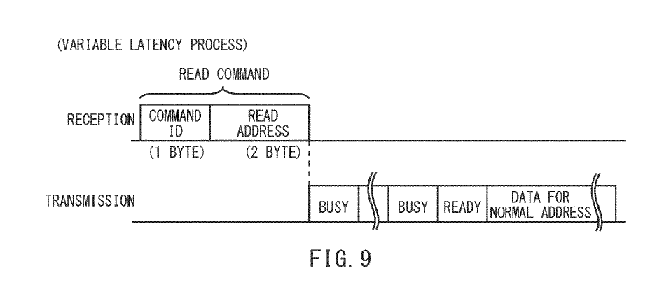

FIG. 9 illustrates timing in which data for a read address is transmitted when the memory controller 30 is performing the variable latency process. In FIG. 9, the read command has the same construction as the read command shown in FIG. 8.

As shown in FIG. 9, when the memory controller 30 performs the variable latency process, it begins transmitting busy signals after it has received the read command. The memory controller 30 continues transmitting busy signals until it becomes possible to read the data for the read address from the semiconductor memory 40. When it is possible to read data from the semiconductor memory 40, the memory controller 30 transmits a ready signal to the host 10. After the ready signal is transmitted, the data for the read address is transmitted to the host 10.

On the other hand, as shown in FIG. 8, the data for the latency-related designated address 45 is transmitted to the host 10 by the fixed latency process. In this case, after the memory controller 30 has finished receiving the read command, it begins transmitting the data for the latency-related designated address 45 at a time point that represents a latency of zero. Since the latency-related designated address 45 has a random value, a third party cannot identify the latency-related designated address 45. Accordingly, even if the memory controller of a duplicate receives a read command including the latency-related designated address 45, it cannot transmit the data for the latency-related designated address 45 to the host 10 at a time point that represents a latency of zero. Thus, a third party cannot fabricate a duplicate of the semiconductor storage apparatus 20.

Further, each time data for a latency-related designated address 45 is read by the host 10, the latency-related designated address 45 is updated in a random manner. Even if a latency-related designated address 45 is leaked, the latency-related designated address 45 has already been updated at the time when the leaking occurs. This makes it more difficult for a third party to identify the latency-related designated address 45, further making it difficult to fabricate a duplicate.

Since the memory controller of a duplicate cannot transmit the data for the latency-related designated address 45 to the host 10 using the fixed latency process, the host 10 cannot process the data stored in the duplicate. An example where the address of page P-2 is a latency-related designated address 45 will be described below with reference to FIG. 4. When the host 10 transmits a read command including the address of page P-2 to the memory controller 30, it performs access control for the fixed latency process. However, the memory controller of the duplicate transmits the data for the address of page P-2 (i.e. program 41B) using the variable latency process. The host 10 uses access control for the fixed latency process to treat the busy signals and ready signal transmitted from the memory controller of the duplicate as the data for the address of page P-2, and thus cannot identify the correct program 41B. The host 10 cannot reconstruct the program 41, and cannot execute the program 41. As a result, a third party cannot fabricate a duplicate that can be used by the host 10.

It is desirable that an address in the semiconductor memory 40 that can be designated as a latency-related designated address 45 be an address that is highly likely to be read by the host 10. It is desirable that an address that can be a latency-related designated address 45 is the address of data that is read by the host 10 at least once, such as a page for storing the boot code for the host 10. Alternatively, it may be limited to an address that is very frequently accessed by the host 10.

As described above, in the present embodiment, the host 10 and memory controller 30 generate a latency-related designated address 45 based on random numbers 13A and 35A, and the data for the latency-related designated address 45 is read from the semiconductor memory 40 and stored in the buffer 34. When the memory controller 30 is instructed to read the data for the latency-related designated address 45, it transmits, to the host 10, the data for the latency-related designated address 45 stored in the buffer 34 at a time point that represents a latency of zero. In other words, the memory controller 30 achieves transmission of data for the latency-related designated address 45 at a time point that represents a latency of zero, which cannot be achieved by the normal read process, by storing in the buffer 34 the data for the latency-related designated address 45, which is preset. Further, since the latency-related designated address 45 is decided in a random manner, a third party cannot identify the latency-related designated address 45. As a result, the memory controller of an illegal duplicate semiconductor storage apparatus fabricated by a third party cannot transmit the data for the latency-related designated address 45 at a time point that represents a latency of zero. This makes it difficult to fabricate an illegal duplicate of the semiconductor storage apparatus 20.

{Variations}

Although the above embodiment describes an implementation where the memory controller 30 outputs the data for the latency-related designated address 45 directly after it has received a read command, the present invention is not limited to such an implementation.

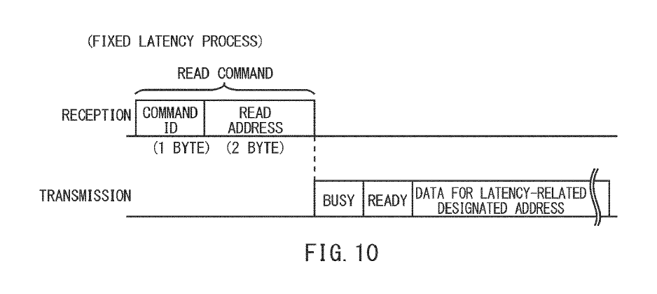

FIG. 10 illustrates another example of timing in which the data for a latency-related designated address 45 is transmitted from the memory controller 30. As shown in FIG. 10, when the memory controller 30 receives a read command, it may output a predetermined pattern (e.g. one busy signal and one ready signal here) and transmit the data for the latency-related designated address 45 to the host 10.

For example, it may be supposed that, when the transmission control unit 333 is to transmit the data for the address included in a read command, it is designed to output at least one busy signal and one ready signal. Then, the transmission control unit 333 transmits one busy signal and one ready signal and then transmits the data for the latency-related designated address 45, thereby responding to the read command with the minimum latency. That is, the minimum latency means the shortest possible time period required for the memory controller upon receiving a read command to begin transmission of the data for the read address. In the example shown in FIG. 10, the minimum latency is shorter than the interval between the time at which the memory controller 30 instructs the semiconductor memory 40 to output the data for the read address and the time at which it receives the data for the read address. In other words, the transmission control unit 333 transmits the data for the latency-related designated address 45 earlier than the time at which it would transmit the data for a read address using the variable latency process. Accordingly, again, a third party cannot identify the latency-related designated address 45, making it difficult for a third party to fabricate a duplicate.

Further, as the memory controller 30 transmits one busy signal and one ready signal in the fixed latency process, it is possible for the host 10 to determine whether the semiconductor storage apparatus 20 is an illegal duplicate or not. This point will be described in detail below.

As discussed above, the memory controller of a duplicate, even after receiving a read command including the latency-related designated address 45, performs the variable latency process to transmit the data for the latency-related designated address 45 to the host 10. That is, the memory controller of the duplicate does not transmit the predetermined pattern (i.e. one busy signal and one ready signal) directly after receiving a read command including the latency-related designated address 45. If the host 10 does not receive the predetermined pattern of busy and ready signals before the data for the latency-related designated address 45 is transmitted, it determines that the semiconductor storage apparatus connected is an illegal duplicate and may stop accessing the semiconductor storage apparatus connected.

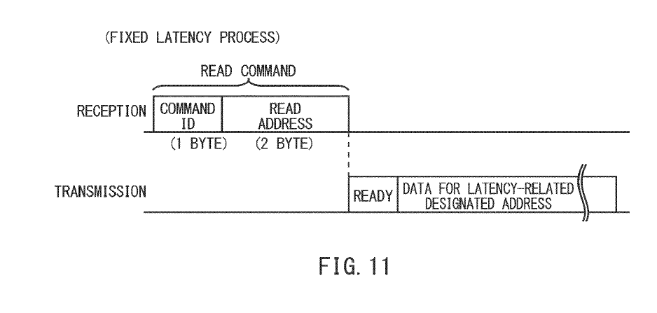

The predetermined pattern is not limited to the example shown in FIG. 10. For example, as shown in FIG. 11, the memory controller 30 may transmit only one ready signal before transmitting the data for a latency-related designated address 45. Alternatively, the memory controller 30 may transmit a plurality of busy signals and one ready signal, or transmit a pattern that is not related to busy or ready signals.

Further, although the above embodiment describes an implementation where an update of the latency-related designated address 45 occurs after the memory controller 30 has transmitted the data for the latency-related designated address 45, the present invention is not limited to such implementations. An update of the latency-related designated address 45 may occur on a regular basis, or may not occur.

Further, although the above embodiment describes an implementation where the latency-related designated address 45 is generated based on the random numbers 13A and 35A, the present invention is not limited to such implementations. For example, the latency-related designated address 45 may be generated based on the random number 13A only. In this case, steps S115, S211, S212, S214 shown in FIG. 5 are omitted. Alternatively, the latency-related designated address 45 may be generated based on the random number 35A only. In this case, steps S111 to S114 and S213 shown in FIG. 5 are omitted.

Further, although the above embodiment describes an implementation where random numbers generated by the host 10 and memory controller 30 are exchanged, the present invention is not limited to such implementations. If the random number generators 13 and 35 are pseudo-random number generators using the same algorithm, the exchanging of random numbers can be omitted. More specifically, both random number generators 13 and 35 generate the same pseudo-random number by updating the random number at predetermined time points. This eliminates the necessity for the host 10 and memory controller 30 to exchange random numbers, thereby improving the confidentiality of the latency-related designated address 45. A time point at which the random number is updated may be, for example, when the reading process based on a read command has occurred a predetermined number of times, or when the host 10 transmits a command for updating the random number. The use of pseudo-random numbers does not restrict the exchange of random numbers. For example, the random number generators 13 and 35 may use different algorithms to generate pseudo-random numbers. In this case, pseudo-random numbers generated by the random number generators 13 and 35 are exchanged.

Further, although the above embodiment describes an implementation where each of the host 10 and memory controller 30 generates the latency-related designated address 45, the present invention is not limited to such implementations. It is only required here that the host 10 and memory controller 30 hold the same latency-related designated address 45.

For example, only the host 10 may generate the latency-related designated address 45. In this case, the latency-related designated address 45 is generated based on the random number 13A only. The host 10 transmits to the memory controller 30 the latency-related designated address 45 generated, instead of a random number exchange command. Conversely, only the memory controller 30 may generate the latency-related designated address 45 and transmit the latency-related designated address 45 generated to the host 10.

Alternatively, an initial value of the latency-related designated address 45 may be pre-set in the host 10 and memory controller 30. Alternatively, an initial value of the latency-related designated address 45 may be pre-set in the host 10 only. In this case, the host 10, upon startup, may transmit the initial value of the latency-related designated address 45 to the memory controller 30.

### Second Embodiment

### 1. Configuration of Memory System

{1.1 Overall Configuration}

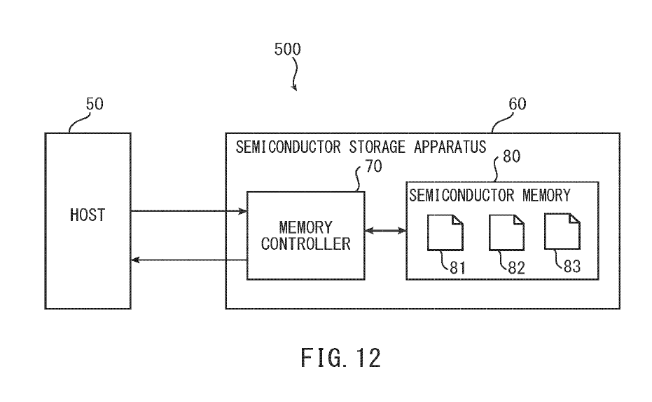

FIG. 12 is a functional block diagram of a memory system 500 according to a second embodiment of the present invention. As shown in FIG. 12, the memory system 500 includes a host 50 and a semiconductor storage apparatus 60. The semiconductor storage apparatus 60 includes a memory controller 70 and a semiconductor memory 80.

In response to a request from the host 50, the memory controller 70 accesses the semiconductor memory 80.

The semiconductor memory 80 is non-volatile, and may be a NAND flash memory, for example. The semiconductor memory 80 stores a program 81, content data 82 and specified address data 83. The program 81 is a program for using the content data 82. The specified address data 83 is used to decide whether the memory controller 70 should perform the fixed latency process or variable latency process. The fixed latency process and variable latency process will be described in detail further below.

{1.2 Configuration of Host 50}

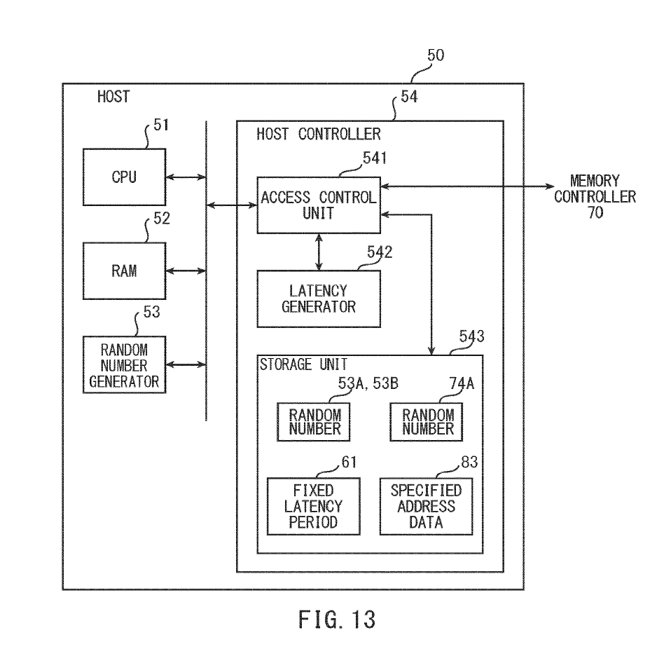

FIG. 13 is a functional block diagram of the host 50 shown in FIG. 12. As shown in FIG. 13, the host 50 includes a central processing unit (CPU) 51, a random access memory (RAM) 52, a random number generator 53, and a host controller 54. The CPU 51, RAM 52, random number generator 53 and host controller 54 are connected via buses.

The CPU 51 executes a program loaded into the RAM 52 to control the operation of the host 50. The RAM 52 is the main memory of the host 50.

The random number generator 53 generates random numbers 53A and 53B to be used to generate a fixed latency period 61. The random number generator 53 generates genuinely random numbers. The random numbers 53A and 53B are generated at different time points. Accordingly, the random numbers 53A and 53B have different values. The fixed latency period 61 is used to perform a fixed latency process. The fixed latency period 61 is used to decide a time point at which the memory controller 70 is to transmit the data for the address included in a read command. The fixed latency period 61 will be described in detail further below.

In response to an instruction by the CPU 51, the host controller 54 controls access by the host 50 to the semiconductor storage apparatus 60. The host controller 54 includes an access control unit 541, a latency generator 542, and a storage unit 543.

The access control unit 541 transmits to the memory controller 70 a command that is based on the instruction by the CPU 51, and receives a response to the transmitted command.

The latency generator 542 generates the fixed latency period 61 from the random number 53A and random number 74A stored in the storage unit 543. The random number 74A is generated by the memory controller 70, as described below.

The storage unit 543 stores the random number 53A, the random number 74A, specified address data 83 and the fixed latency period 61. The specified address data 83 is transmitted from the memory controller 70 upon startup of the host 50.

{1.3 Configuration of Memory controller 70}

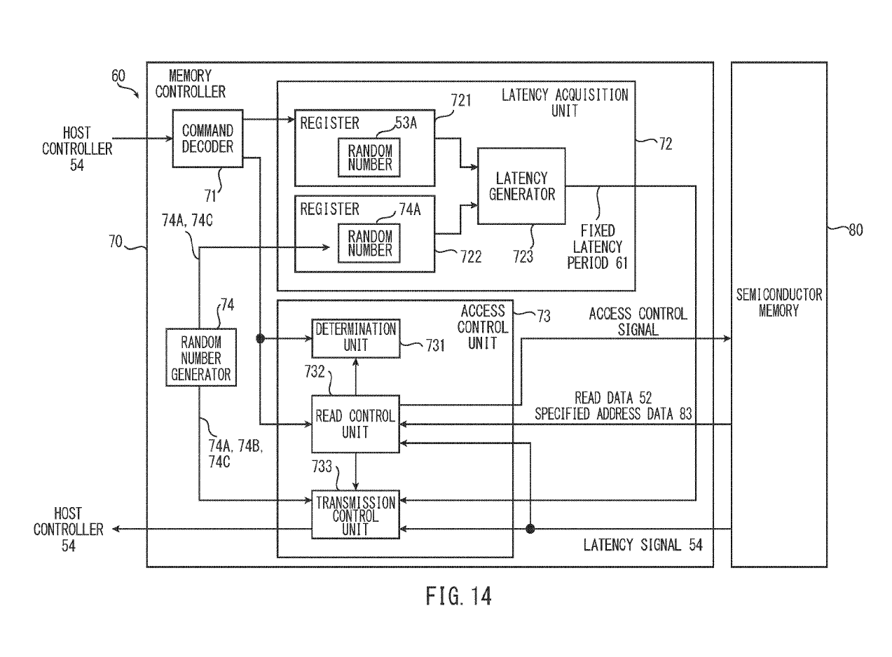

FIG. 14 is a functional block diagram of the semiconductor storage apparatus 60 shown in FIG. 12. As shown in FIG. 14, the memory controller 70 includes a command decoder 71, a latency acquisition unit 72, an access control unit 73, and a random number generator 74.

The memory controller 70 is connected to the host controller 54. In FIG. 14, the interface circuit in the memory controller 70 connecting to the host 50 (i.e. host I/F) and the interface circuit connecting to the semiconductor memory 80 (i.e. memory I/F) are not shown.

The command decoder 71 receives a command transmitted by the host controller 54 and decodes the received command. For example, if the command decoder 71 receives a read command, it extracts the address included in the read command and provides the read instruction and the extracted address to the access control unit 73. The address included in the read command will be hereinafter referred to as “read address”.

The latency acquisition unit 72 acquires the fixed latency period 61. The latency acquisition unit 72 includes a register 721, a register 722 and a latency generator 723.

The register 721 stores the random number 53A, which is generated by the random number generator 53 (see FIG. 13). The register 722 stores the random number 74A, which is generated by the random number generator 74. The latency generator 723 generates the fixed latency period 61 from the random number 53A stored in the register 721 and the random number 74A stored in the register 722. The fixed latency period 61 generated by the latency generator 723 is the same as the fixed latency period 61 generated by the latency generator 542 of the host 50 shown in FIG. 13.

In response to the read command from the host 50, the access control unit 73 reads data from the semiconductor memory 80 and transmits the data that has been read to the host controller 54. The access control unit 73 includes a determination unit 731, a read control unit 732 and a transmission control unit 733.

The determination unit 731 uses the specified address data 83 to determine whether the read address is to be treated in the fixed latency process. The specified address data 83 has registered therein addresses in the semiconductor memory 80 that are to be treated in the fixed latency process. If the read address matches an address registered in the specified address data 83, the determination unit 731 decides to perform the fixed latency process. If the read address does not match an address registered in the specified address data 83, the determination unit 731 decides to perform the variable latency process. The variable latency process is the same as the normal read process.

The read control unit 732 controls reading of data from the semiconductor memory 80. The read control unit 732 transmits an access control signal including the read address to the semiconductor memory 80 to instruct the semiconductor memory to read the data.

The read control unit 732 provides to the transmission control unit 733 the data read from the semiconductor memory 80 in response to the access control signal. The data read form the semiconductor memory 80 in response to a read command will be hereinafter referred to as “read data 62”. Further, the read control unit 732 reads the specified address data 83 from the semiconductor memory 80 upon startup of the memory controller 70. The specified address data 83 read is provided to the determination unit 731 and transmission control unit 733.

Depending on the result of determination by the determination unit 731, the transmission control unit 733 performs the fixed latency process or variable latency process. During the variable latency process, in response to the latency signal 64 from the semiconductor memory 80, the transmission control unit 733 initiates transmission of the read data 62 to the host 50. The latency signal 64 indicates that it is possible to read data from the semiconductor memory 80. During the variable latency process, the fixed latency period 61 is not used.

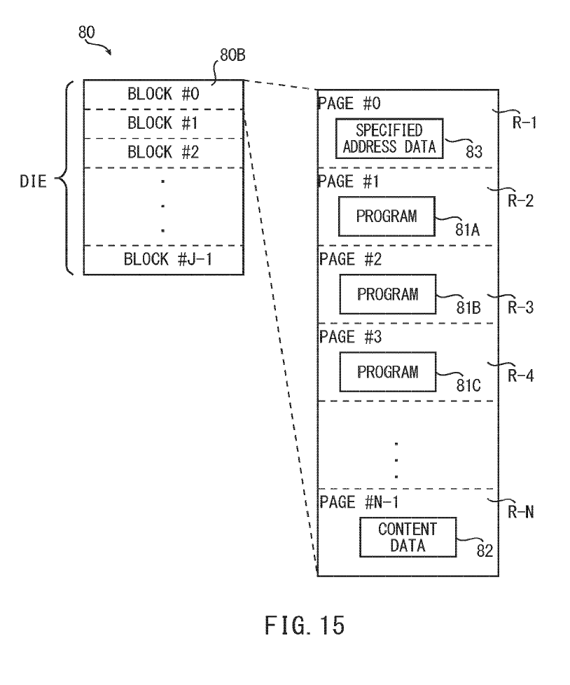

On the other hand, during the fixed latency process, the transmission control unit 733 waits until the time of completion of the fixed latency period 61 starting at the time at which the read command is received, and then transmits the read data 62. The fixed latency period 61 is longer than the interval between the time at which the read control unit 732 instructs the semiconductor memory 80 to read the data for the read address and the time at which it becomes possible to read data from the semiconductor memory 80. For example, if the data for the address of page R-3 (see FIG. 15) is transmitted to the host 50, the time at which the data for the address of page R-3 is transmitted during the fixed latency process is later than that during the variable latency process.

The random number generator 74 generates the random numbers 74A to 74C. The random numbers 74A and 74C are used to decide the fixed latency period 61. The random number 74B is used to transmit a concealment signal, described below. The random numbers 74A to 74C are generated at different time points. The random number generator 74 generates genuinely random numbers such that the random numbers 74A to 74C have different values.

{1.4 Configuration of Semiconductor Memory 80}

FIG. 15 is a functional block diagram of the semiconductor memory 80 shown in FIG. 12. As shown in FIG. 15, the semiconductor memory 80 is formed by one die. The die includes J blocks. Each block includes N pages. J and N are natural numbers equal to or greater than 1. A block is the unit of data for deletion in the semiconductor memory 80. A page is the unit of data for reading and writing in the semiconductor memory 80.

In the semiconductor memory 80, the block 80B includes pages R1, R2, . . . R-N. The specified address data 83 is stored in page R-1. The programs 81A to 81C are stored in pages R-2 to R-4, respectively. The programs 81A to 81C constitute the program 81 shown in FIG. 12. The programs 81A to 81C are generated by dividing the program 81 into sub-programs (i.e. programs 81A to 81C) with a data size that allows storage in a page. Accordingly, the programs 81A to 81C cannot be executed separately. The content data 82 is stored in page R-N.

### 2. Operation of Memory System

The decision on the fixed latency period 61, the variable latency process, the fixed latency process, and the update of the fixed latency period 61 performed in the memory system 500 will be described below. In the description below, no description of the process of converting a logical address to a physical address performed by the memory controller 70 will be given.

{2.1 Decision on Fixed Latency Period 61}

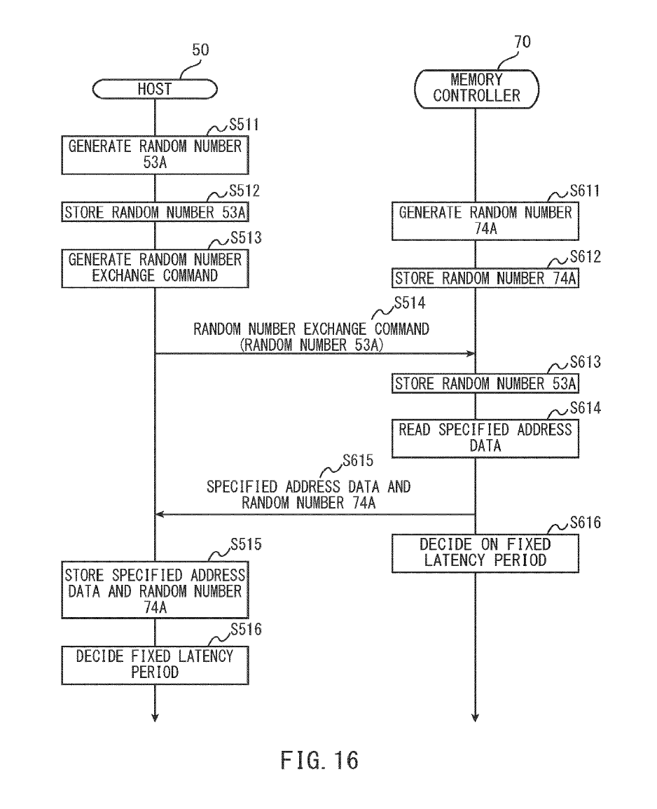

FIG. 16 is a sequence diagram illustrating the operations performed by the host 50 and memory controller 70 to decide the fixed latency period 61.

A reference time used to decide the fixed latency period 61 is pre-set as an initial state in the host 50 and memory controller 70. The reference time is the maximum time required for the memory controller 70 upon instructing the semiconductor memory 80 to read data to receive the latency signal 64 from the semiconductor memory 80. That is, the reference time means the maximum time required to read data from the semiconductor memory 80. The maximum time is acquired by measuring in advance the interval from the time at which the memory controller instructs the semiconductor memory 80 to read data to the time at which it receives the latency signal 54. Alternatively, the maximum time may be decided depending on the design of the semiconductor memory 80.

The reference time may be stored in a predetermined region of the semiconductor memory 80. In this case, the host 50 upon startup acquires the reference time via the memory controller 70.

The sequence diagram shown in FIG. 16 is initiated when the host 50 is powered on. The operation of the host 50 will be described first. When the host 50 is powered on, the CPU 51 instructs the random number generator 53 to generate a random number 53A. In response to the instruction by the CPU 51, the random number generator 53 generates a genuinely random number 53A (step S511). The generated random number 53A is provided to the CPU 51 and host controller 54.

The access control unit 541 in the host controller 54 stores the random number 53A from the random number generator 53 in the storage unit 543 (step S512).

The CPU 51 generates a random number exchange command (step S513). The CPU 51 attaches the random number 53A from the random number generator 53 to the random number exchange command. The random number exchange command is a command for transmitting the random number 53A to the memory controller 70 and requesting transmission of a random number 74A and the specified address data 83.

The access control unit 541 receives from the CPU 51 the random number exchange command with the random number 53A attached to it. The host controller 54 transmits the received random number exchange command to the memory controller 70 (step S514). The access control unit 541 waits until it receives a response to the random number exchange command.

Next, the operation of the memory controller 70 will be described. The memory controller 70 starts up following the powering-on of the host 50. The random number generator 74 in the memory controller 70 generates a random number 74A (step S611). Similar to the random number generator 53, the random number generator 74 generates genuinely random numbers. Accordingly, the random numbers 53A and 74A generated upon startup of the memory system 500 have different values.

The random number generator 74 provides the generated random number 74A to the register 722 and transmission control unit 733. The register 722 stores the received random number 74A (step S612).

The memory controller 70 receives the random number exchange command transmitted by the host controller 54 at step S514. The memory controller 70 stores in the register 721 the random number 53A attached to the received random number exchange command (step S613). More specifically, the command decoder 71 decodes the received random number exchange command and determines that the host 50 is requesting exchange of random numbers. The command decoder 71 extracts the random number 53A attached to the random number exchange command and provides it to the register 721. The register 721 stores the random number 53A received from the command decoder 71.

The command decoder 71 informs the read control unit 732 and transmission control unit 733 that it has received a random number exchange command. In response to the informing by the command decoder 71, the read control unit 732 reads the specified address data 83 from the semiconductor memory 80 (step S614).

In response to the informing by the command decoder 71, the transmission control unit 733 acquires the specified address data 83 from the read control unit 732, and acquires the random number 74A from the random number generator 74. The transmission control unit 733 transmits the acquired random number 74A and specified address data 83 to the host 50 as a response to the random number exchange command (step S615).

The latency acquisition unit 72 generates a fixed latency period 61 (step S616). More specifically, the latency generator 723 uses a predetermined algorithm to calculate a fixed latency period 61 that is longer than the reference time based on the random number 53A stored in the register 721 and the random number 74A stored in the register 722. The process performed when a fixed latency period 61 shorter than the reference time results will be described further below.

The algorithm used for calculation is not limited to a particular one. For example, a pseudo-random number generation algorithm, hash-based message authentication code (HMAC), etc. may be used.

If a fixed latency period 61 shorter than the reference time results, a fixed latency period 61 may be generated again. In this case, the host 50 transmits a random number exchange command including a new random number generated by the random number generator 53. When the memory controller 70 receives the random number exchange command, it transmits a new random number generated by the random number generator 74 to the host 50. The latency generators 542 and 723 generate a fixed latency period 61 from the two new random numbers generated. The host 50 and memory controller 70 may generate a fixed latency period 61 repeatedly until a fixed latency period 61 longer than the reference time results.

The latency generator 723 provides the decided fixed latency period 61 to the transmission control unit 733. The transmission control unit 733 holds the fixed latency period 61 from the latency generator 723. With this, the process performed by the memory controller 70 upon startup ends.

The access control unit 541 in the host 50 receives the random number 74A and specified address data 83 and recognizes it as a response to the random number exchange command. The access control unit 541 stores the received random number 74A and specified address data 83 in the storage unit 543 (step S515).

The latency generator 542 generates a fixed latency period 61 from the random numbers 53A and 74A stored in the storage unit 543 (step S516). The algorithm used by the latency generator 542 to generate the fixed latency period 61 is the same as the algorithm used by the latency generator 723 in the memory controller 70. Accordingly, the fixed latency period 61 generated by the latency generator 542 is equal to the fixed latency period 61 generated by the latency generator 723 in the memory controller 70.

{2.2 Variable Latency Process}

When the memory controller 70 receives from the host 50 a read command including an address that is not registered in the specified address data 83, it performs the variable latency process to transmit the data for the address included in the read command.

An address registered in the specified address data 83 will be hereinafter referred to as “specified address”, and an address not registered in the specified address data 83 will be referred to as “normal address”.

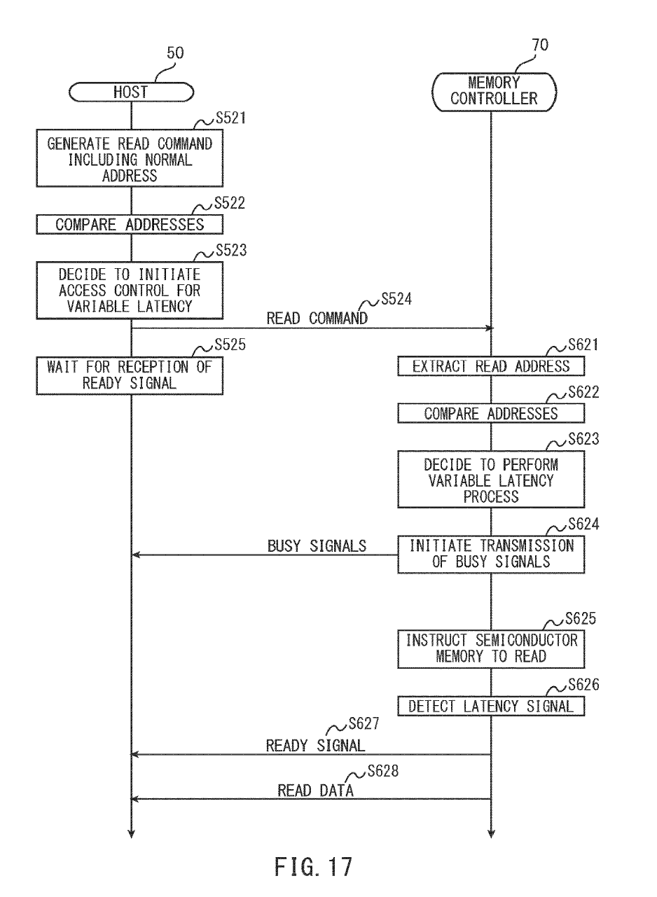

FIG. 17 is a sequence diagram illustrating the operations of the host 50 and memory controller 70 performed when the host 50 transmits a read command including a normal address as a read address.

As shown in FIG. 17, the host 50 performs steps S521 to S524 to transmit a read command including a normal address to the memory controller 70. More specifically, the CPU 51 generates a read command and attaches a read address to the generated read command. In the example shown in FIG. 17, the read address attached is a normal address. Thus, a read command including a normal address is generated (step S521).

The CPU 51 provides the generated read command to the access control unit 541. The access control unit 541 compares the read address included in the read command to the addresses registered in the specified address data 83 (step S522).

Since the read address attached to the read command is a normal address in the example shown in FIG. 17, the read address included in the read command does not match an address registered in the specified address data 83. As such, the access control unit 541 determines that, when it transmits the read command to the memory controller 70, the memory controller 70 will perform the variable latency process. The access control unit 541 decides to initiate access control for the variable latency process after transmitting the read command (step S523).

The access control unit 541 transmits the read command generated at step S521 to the memory controller 70 (step S524). The access control unit 541 initiates access control for the variable latency process by waiting until it receives a ready signal from the memory controller 70 (step S525).

The command decoder 71 in the memory controller 70 receives the read command transmitted by the host 50 at step S524. The command decoder 71 decodes the read command received. As such, the command decoder 71 determines that the host 50 has instructed the memory controller 70 to read data, and extracts the read address from the read command received (step S621).

The command decoder 71 provides the result of the decoding (i.e. read instruction and extracted read address) to the determination unit 731 and read control unit 732. The determination unit 731 compares the read address received from the command decoder 71 to the addresses registered in the specified address data 83 (step S622). Since the read address attached to the read command is a normal address in the example shown in FIG. 17, the read address received does not match an address registered in the specified address data 83. Thus, the determination unit 731 decides to perform the variable latency process (step S623).

Based on the determination by the determination unit 731, the transmission control unit 733 initiates the variable latency process. More specifically, the transmission control unit 733 initiates transmission of busy signals to the host 50 (step S624). The transmission of busy signals is continued until the transmission control unit 733 detects a latency signal 64 from the semiconductor memory 80.

The read control unit 732 provides the access control signal including the read address to the semiconductor memory 80 to instruct the semiconductor memory 80 to read the data for the read address (step S625). After the read control unit 732 transmits the access control signal, it transitions to a state for waiting to receive a latency signal 54.

In response to the access control signal transmitted by the read control unit 732, the semiconductor memory 80 initiates preparation for reading the data for the read address. When the preparation for reading is finished, the semiconductor memory 80 provides a latency signal 64 to the read control unit 732 and transmission control unit 733 to inform that it is ready to output the data for the read address.

The transmission control unit 733 detects the latency signal 64 transmitted by the semiconductor memory 80 (step S626). In response to the latency signal 64 detected, the transmission control unit 733 transmits a ready signal to the host 50 (step S627).

After the semiconductor memory 80 has output the latency signal 64, it begins to output the data for the read address (i.e. read data 62). The transmission control unit 733 reads the read data 62 via the read control unit 732. The transmission control unit 733 transmits the read data 62 to the host 50 such that the read data follows the ready signal (step S628).

When the access control unit 541 in the host 50 detects the ready signal, it determines that transmission of the read data 52 will be initiated. The access control unit 541 receives the transmitted data following the ready signal and regards it as the read data 62. The CPU 51 performs a process using the read data 62 received by the access control unit 541.

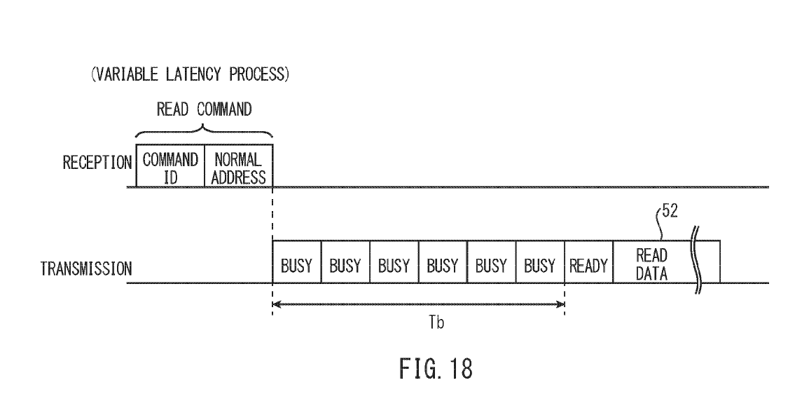

FIG. 18 illustrates timing in which the read data 62 is transmitted when the variable latency process is performed. As shown in FIG. 18, if the memory controller 70 determines that the read address does not match any one of the addresses registered in the specified address data 83, it initiates transmission of busy signals directly after receiving the read command. The transmission of busy signals is continued until a latency signal 64 from the semiconductor memory 80 is detected. Then, when a latency signal 64 is detected, the memory controller 70 transmits a ready signal instead of a busy signal and transmits the read data 62 such that it follows the ready signal.

The latency signal 64 is output when preparations for reading at the semiconductor memory 80 are finished. However, the time required for the preparations for reading varies depending on the performance of the semiconductor memory 80, the read address and other factors, the period of time during which busy signals are transmitted, Tb, is not constant. In view of this, if the memory controller 70 is performing the variable latency process, the host 50 waits until it receives a ready signal. The host 50 uses the ready signal as a trigger and receives the transmitted data following the ready signal and treats it as the read data 62.

{2.3 Fixed Latency Process}

If the read address matches an address registered in the specified address data 83, the memory controller 70 performs the fixed latency process to transmit the read data 62. In the fixed latency process, unlike in the variable latency process, the time point at which the read data 62 is transmitted is decided on depending on the fixed latency period 61.

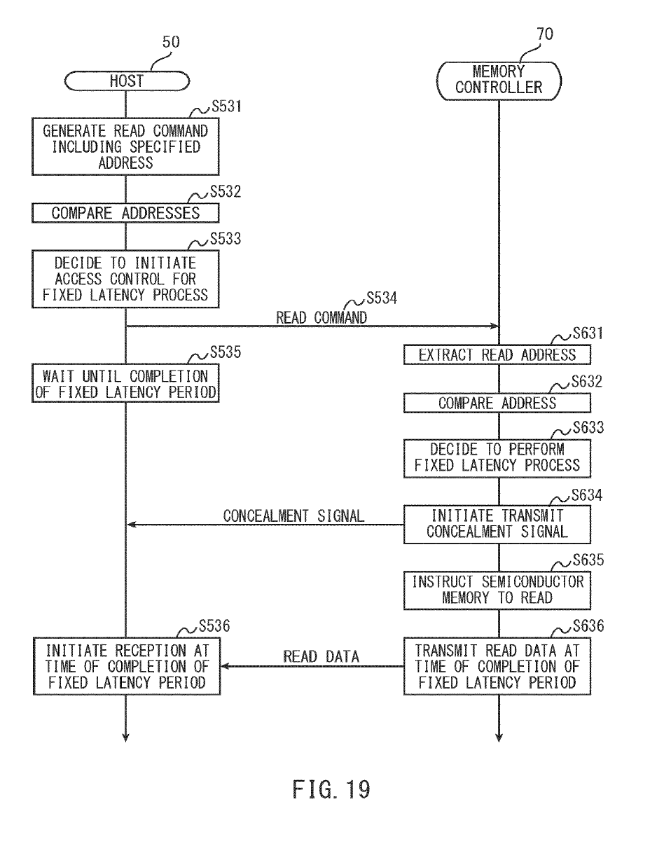

FIG. 19 is a sequence diagram illustrating the operations of the host 50 and memory controller 70 performed when the host 50 transmits a read command including the specified address.

The host 50 performs steps S531 to S534 to transmit a read command including the specified address to the memory controller 70. More specifically, the CPU 51 generates a read command and attaches a read address to it. In the example shown in FIG. 19, the read address is the specified address. Thus, a read command including the specified address is generated (step S531).

The CPU 51 provides the read command generated to the access control unit 541. The access control unit 541 compares the read address included in the read command to the addresses registered in the specified address data 83 (step S532).

Since the read address attached to the read command is the specified address in the example shown in FIG. 19, the read address matches one of the addresses registered in the specified address data 83. As such, the access control unit 541 determines that, when it transmits the read command generated at step S531, the memory controller 70 will perform the fixed latency process. The access control unit 541 decides to initiate access control for the fixed latency process after transmitting the read command (step S533).

The access control unit 541 transmits the read command generated at step S531 to the memory controller 70 (step S534). The access control unit 541 waits until the time of completion of the fixed latency period 61 starting at the time at which it transmitted the read command (step S535). The access control unit 541 receives a concealment signal from the memory controller 70 until the fixed latency period 61 is completed. As discussed further below, a concealment signal is random data, and the access control unit 541 does not use the concealment signal but the fixed latency period 61 to identify the time point at which the read data 62 will be received.

The command decoder 71 in the memory controller 70 receives the read command transmitted by the host 50 at step S534. The command decoder 71 decodes the read command received. As such, the command decoder 71 determines that the memory controller 70 has been instructed by the host 50 to read, and extracts the read address from the read command received (step S631).

The command decoder 71 provides the result of the decoding (i.e. read instruction and extracted read address) to the determination unit 731 and read control unit 732. The determination unit 731 compares the read address received from the command decoder 71 to the addresses registered in the specified address data 83 (step S632). Since the read address attached to the read command is the specified address in the example shown in FIG. 19, the read address received matches one of the addresses registered in the specified address data 83. Thus, the determination unit 731 decides to perform the fixed latency process (step S633).

The memory controller 70 performs steps S634 to S636 which form the fixed latency process. The transmission control unit 733 begins to transmit a concealment signal instead of busy signals (step S634). More specifically, the transmission control unit 733 continues to receive random numbers 74B from the random number generator 74 until the time of completion of the fixed latency period 61 starting at the time at which it received the read command, and transmits the received random numbers 74B as a concealment signal. In other words, the concealment signal continues to be updated with random numbers 74B generated by the random number generator 74 until the fixed latency period 61 is completed. Since the random number generator 74 generates random numbers 74B at time points different from the time points at which random numbers 74A are generated, random numbers 74B are different from random numbers 74A. Transmission of the concealment signal is continued until the time of completion of the fixed latency period 61 starting at the time at which the read command is received.

The concealment signal has random values. On the other hand, busy signals and ready signals have predetermined patterns. If a concealment signal is transmitted instead of busy and ready signals, a third party cannot distinguish between the busy signals, the ready signal and the transmitted data for the read address following the ready signal. In other words, the period for which busy signals are transmitted and the values of the busy signals are concealed by the random numbers 74B, thereby concealing the time point at which the read data 62 is transmitted.

Next, the read control unit 732 provides an access control signal including the read address to the semiconductor memory 80 to instruct the semiconductor memory 80 to read the data for the read address (step S635). In response to the access control signal from the read control unit 732, the semiconductor memory 80 initiates preparation for reading the data for the read address. When the preparation for reading is finished, the semiconductor memory 80 provides a latency signal 64 to the transmission control unit 733 to inform that it is ready to read the data for the read address.

As discussed above, the fixed latency period 61 is longer than the reference time. The reference time is the maximum time required for the memory controller upon instructing the semiconductor memory 80 to read data to receive the latency signal 64 from the semiconductor memory 80. As such, during the fixed latency process, the transmission control unit 733 detects the latency signal 64 while waiting until the time of completion of the fixed latency period 61 starting at the time at which the read command is received. However, the transmission control unit 733 does not initiate transmission of the read data 62 even when it has detected the latency signal 64, but continues to transmit the concealment signal.

The transmission control unit 733 initiates transmission of the read data 62 at the time of completion of the fixed latency period 61 starting at the time at which reception of the read command was finished (step S636). More specifically, the transmission control unit 733 stops transmitting the concealment signal at the time at which the fixed latency period 61 is completed. The transmission control unit 733 reads the read data 62 from the semiconductor memory 80 via the read control unit 732. The transmission control unit 733 transmits the read data 62 instead of the concealment signal to the host 50.

Attention will be given to the host 50 again. As discussed above, the access control unit 541 transmits the read command (step S534), and then waits until the time of completion of the fixed latency period 61 (step S535). The access control unit 541 ignores the concealment signal that it receives while waiting. The access control unit 541 initiates reception of the read data 62 at the time point at which the fixed latency period 61 is completed (step S536). That is, the access control unit 541 receives data after the time point at which the fixed latency period 61 is completed and treats this data as the read data 62. Thus, when performing access control for the fixed latency process, the host 50 needs not detect a ready signal.

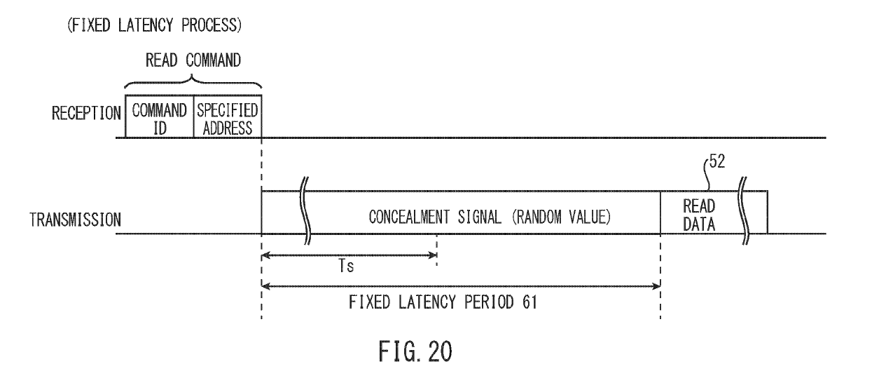

FIG. 20 illustrates timing in which the read data 62 is transmitted when the fixed latency process is being performed. As shown in FIG. 20, at the time of completion of the period Ts starting at the time at which the memory controller 70 receives the read command, the memory controller 70 receives the latency signal 64 indicating that it is possible to read the data for the read address. However, the memory controller 70 ignores the latency signal 64 and waits until the fixed latency period 61 is completed. Further, if the read address matches an address registered in the specified address data 83, the memory controller 70 begins to transmit a concealment signal upon reception of the read command. The concealment signal is composed of random numbers 74B generated by the random number generator 74. As such, even if a third party observes signals transmitted by the memory controller 70, it cannot detect busy signals or a ready signal. Upon completion of the fixed latency period 61, the memory controller 70 begins to transmit the read data 62 such that it follows the concealment signal, the third party cannot identify the time point at which the read data 62 is transmitted, and thus cannot identify the read data 62.

The host 50 and memory controller 70 hold the same fixed latency period 61. As such, the host 50 can identify the time point at which the read data 62 will be received based on the time at which transmission of the read command was finished and on the fixed latency period 61. The memory controller 70 can identify the time point at which the read data 52 is to be transmitted based on the time point at which reception of the read command is finished and on the fixed latency period 61. As such, the host 50 can identify the read data 62 transmitted from the memory controller 70 without using busy signals or a ready signal.

In implementations where the reference time used to generate the fixed latency period 61 is decided by measuring the latency signal 64, the memory controller 70 may not detect the latency signal 64 by the time at which the fixed latency period 61 is completed. In this case, the memory controller 70 cannot obtain the read data 62, and thus cannot transmit the read data 62 to the host 50. The memory controller 70 transmits an error signal as a response to the read command at the time at which the fixed latency period 61 is completed. The host 50 and memory controller 70 perform the process for updating the fixed latency period 61 described below. It is desirable that the updated fixed latency period 61 be longer than the fixed latency period 61 before the update. Then, the host 50 suitably transmits the read command to the memory controller 70 once again.

Thus, the memory controller 70 performs the fixed latency process when it has received a read command including the specified address. Since the fixed latency period 61 generated based on the random numbers 53A and 74A are random, a third party cannot identify the fixed latency period 61. The memory controller of an illegal duplicate of the semiconductor storage apparatus 60 cannot reproduce the operation of the memory controller 70 for performing the fixed latency process using the fixed latency period 61. An illegal duplicate of the semiconductor storage apparatus 60 will be hereinafter simply referred to as “duplicate”.

For example, referring to FIG. 15, the programs 81A to 81C are generated by simply dividing the program 81 into sub-programs with a data size. If the address of page R-3 is registered in the specified address data 83, the memory controller 70 transmits the program 81B stored in page R-3 using the fixed latency process. On the other hand, the memory controller of a duplicate cannot transmit the program 81B to the host 50 using the fixed latency process since the third party has not identified the fixed latency period 61. If a duplicate is connected to the host 50, the host 50 cannot reconstruct the program 81, and thus cannot use the program 81. Thus, a third party cannot fabricate a duplicate that can be used by the host 50. Further, since the memory controller 70 uses random numbers 74B to conceal busy signals and a ready signal, a third party cannot identify the read data 62 transmitted by the host 50 using the fixed latency process. Thus, a third party cannot duplicate the data for the specified address stored in the semiconductor memory 80.

Next, the addresses registered in the specified address data 83 will be described. The addresses registered in the specified address data 83 may be the addresses of all the pages in the semiconductor memory 80, or may be the addresses of some pages. In implementations where the addresses of some pages are registered in the specified address data 83, it is desirable that the addresses registered be the addresses of data that is read at least once by the host 50. For example, the addresses of those regions in the semiconductor memory 80 that the host 50 must access, such as the addresses of the pages storing the boot code for the host 50 may be registered. Alternatively, the address of the regions that the host 50 frequently accesses may be registered.

{2.4 Update of Fixed Latency Period 61}

After the memory controller 70 has transmitted the read data 62 using the fixed latency process, the host 50 and memory controller 70 update the fixed latency period 61. The process for updating the fixed latency period 61 is the same as that for deciding on the fixed latency period 61 shown in FIG. 16 except for the following: referring to FIG. 16, when the fixed latency period 61 is to be updated, the host 50 generates a random number 53B different from the random number 53A and stores it in the storage unit 543 (steps S511 and S512). A random number exchange command having the random number 53B attached thereto is transmitted to the memory controller 70 (step S514). The memory controller 70 generates a random number 74C different from the random numbers 74A and 74B (step S611), and transmits the random number 74C as a response to the random number exchange command (step S615). As a result, the host 50 and memory controller 70 generate a fixed latency period 61 different from the fixed latency period 61 generated upon startup. After the new fixed latency period 61 is generated (step S516, see FIG. 16), the host 50 generates a next read command and transmits it.

For example, an update of the fixed latency period 61 occurs in the memory controller 70 between the time point at which the memory controller transmits the data for the specified address and the time point at which the memory controller receives a next read command. In the host 50, an update of the fixed latency period 61 occurs from the time point at which the host receives the data for the specified address and the time point at which the host generates a next read command. In short, the host 50 and memory controller 70 does updating in a predetermined interval starting at the time at which the process of reading the data for the specified address is finished. Since the fixed latency period 61 is updated at the same time point, the host 50 and memory controller 70 can hold the same fixed latency period 61.

Since the random number generators 53 and 34 generate genuinely random numbers, the random numbers generated by the random number generators 53 and 34 are not reproducible. That is, the random numbers 53B and 74C used to update the fixed latency period 61 are different from the random numbers 53A and 74A and 74B. Since the fixed latency period 61 after an update is decided irrespective of the fixed latency period 61 before the update, a third party cannot predict the fixed latency period after the update. A third party may manage to identify the length of the concealment signal (i.e. fixed latency period 61) by observing the concealment signal output from the memory controller 70; to address this situation, the fixed latency period 61 is updated. The identified fixed latency period 61 is not used when the data for a next specified address is read. That is, while a third party may manage to identify a fixed latency period 61, it cannot identify a fixed latency period 61 after an update. Thus, the third party cannot identify the data for the next specified address.

Thus, in the memory system 500 according to the present embodiment, the host 50 and memory controller 70 hold the same fixed latency period 61. When the memory controller 70 receives from the host 50 a read command including the specified address, it initiates transmission of the data for the specified address at the time point decided based on the fixed latency period 61, and the host 50 initiates reception of the data for the specified address at the time point decided based on the fixed latency period 61. Since a third party cannot identify the fixed latency period 61, it cannot reproduce the operation of the memory controller 70 for deciding the time point at which the data for the specified address is transmitted based on the fixed latency period 61. Thus, a third party cannot fabricate an illegal duplicate of the semiconductor storage apparatus 60 that can be used by the host 50.

Further, since the fixed latency period 61 is concealed by random numbers 74B, it is difficult for a third party to identify the read data 62, thereby improving tamper resistance. Further, since the fixed latency period 61 is updated, it is still more difficult for a third party to identify the read data 62, further improving tamper resistance.

{Variation 1}

Although the above embodiment describes implementations where the host 50 performing access control for the fixed latency process ignores a concealment signal that it receives during the fixed latency period 61, the present invention is not limited to such implementations. The host 50 may determine whether the semiconductor storage apparatus 60 is an illegal duplicate by monitoring a signal that it receives until the fixed latency period 61 is completed.

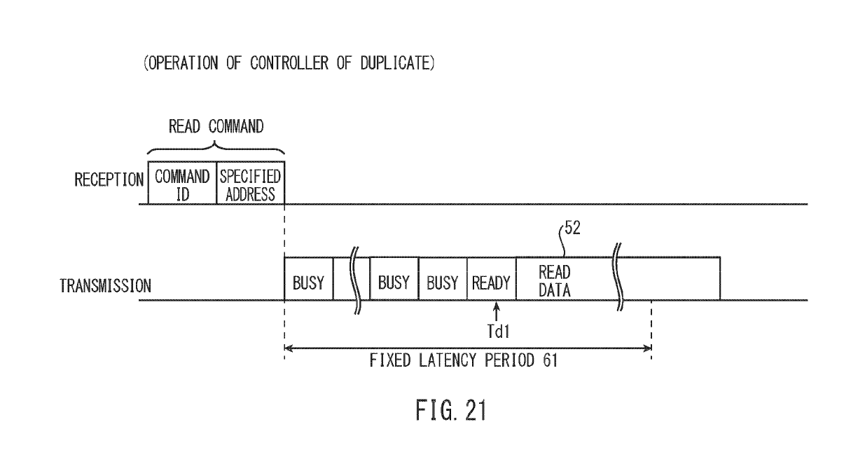

FIG. 21 illustrates timing in which the memory controller 70 of a duplicate transmits read data 62 after the host 50 has transmitted a read command including the specified address. Before the host 50 transmits a read command including the specified address, it may identify the time point at which it will receive a ready signal in advance. More specifically, the host 50 determines that the time point at which it will receive a ready signal is directly before the end of the fixed latency period 61.

The memory controller of a duplicate cannot perform the fixed latency process. As such, when the memory controller of the duplicate receives from the host 50 the read command including the specified address, it transmits the read data 52 using the normal read process (i.e. variable latency process) instead of the fixed latency process. Assuming that, for example, the memory controller of the duplicate detects the latency signal 64 at time Td1, then, it transmits a ready signal at time Td1, which precedes the completion of the fixed latency period 61. Or, if the memory controller of the duplicate detects a ready signal after the fixed latency period 61 is completed, it transmits the ready signal after the fixed latency period 61 is completed.

As a result, the host 50 receives a ready signal from the memory controller of the duplicate at a time point different from the time point for reception that has been identified in advance, and thus determines that the semiconductor storage apparatus 60 that transmitted the ready signal is a duplicate.

{Variation 2}

Although the above embodiment describes implementations where the memory controller 70 refers to the specified address data 83 to determine whether the read address matches a specified address, the present invention is not limited to such implementations.

The host 50 may generate a read command including an instruction flag for instructing a memory controller to perform one of the variable latency process and the fixed latency process. In a read command, an instruction flag is affixed to the end of the read address. For example, the flag for the variable latency process may be “00” and the flag for the fixed latency process may be “01”. The memory controller 70 decides to perform the variable latency process or fixed latency process depending on the value of the instruction flag. In this implementation, the memory controller 70 need not perform the steps for comparing the read address to the addresses registered in the specified address data 83 (i.e. steps S622 and S632).

Alternatively, the host 50 and memory controller 70 may determine whether to perform the fixed latency process based on the length of the fixed latency period 61. In such implementations, a threshold to which the fixed latency period 61 is to be compared is pre-set in the host 50 and memory controller 70.

If the host 50 and memory controller 70 has generated the fixed latency period 61 using the process shown in FIG. 16, they compare the fixed latency period 61 to the threshold. If the fixed latency period 61 is longer than the threshold, the host 50 performs access control for the fixed latency process and the memory controller 70 performs the fixed latency process. After the host 50 has received the read data 62, the host 50 and memory controller 70 update the fixed latency period 61 and compare it to the threshold again.

On the other hand, if the fixed latency period 61 generated is equal to or shorter than the threshold, the host 50 performs access control for the variable latency process and the memory controller 70 performs the variable latency process. After the host 50 has received the read data 62, the host 50 and memory controller 70 update the fixed latency period 61 and compares it to the threshold again.

{Variation 3}

Although the above embodiment describes embodiments where the memory controller 70 performing the fixed latency process waits to transmit the read data 62 until the time of completion of the fixed latency period 61 starting at the time of the reception of the read command, the present invention is not limited to such implementations.

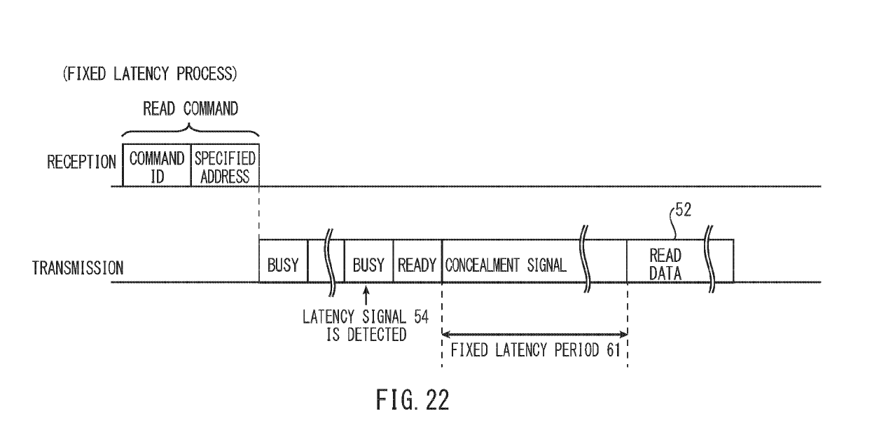

The memory controller 70 may wait to transmit the read data 62 until the time of completion of the fixed latency period 61 starting at the time of the detection of the latency signal 64. FIG. 22 illustrates another example of timing in which the read data 62 is transmitted.

As shown in FIG. 22, after the memory controller 70 has received the read command, it initiates transmission of busy signals instead of a concealment signal. The reason for doing this will be described further below. When the memory controller 70 detects a latency signal 64, it transmits a ready signal instead of a busy signal. Then, the memory controller 70 initiates transmission of a concealment signal such that the concealment signal follows the ready signal.

The host 50 determines that the ready signal represents the time point at which the fixed latency period 61 starts, and waits until the time of completion of the fixed latency period 61 starting at the time of the reception of the ready signal. Upon completion of the fixed latency period 61 starting at the time at which the memory controller 70 transmitted the ready signal, the memory controller 70 initiates transmission of the read data 62. In other words, the memory controller 70 uses the busy signals and ready signal to inform the host 50 of the time at which the fixed latency period 61 starts. This implementation also makes it possible to conceal the time point at which the read data 62 is transmitted.

{Other Variations}

Although the above embodiment describes implementations where the memory controller 70 transmits a concealment signal from the time point at which the memory controller receives a read command until the time of completion of the fixed latency period 61 starting at that time point, the present invention is not limited to such implementations. The memory controller 70 may transmit busy signals and a ready signal instead of a concealment signal from the time at which it finishes reception of the read command until the time of completion of the fixed latency period 61 starting at that time point. In such implementations, too, the time at which the data for the specified address is transmitted is decided based on the fixed latency period 61. Since a third party cannot identify the fixed latency period 61, the memory controller of a duplicate cannot transmit a ready signal at a time point decided based on the fixed latency period 61. Thus, implementations that do not use a concealment signal can make it difficult to fabricate a duplicate.

Although the above embodiment describes implementations where each of the host 50 and memory controller 70 generates a fixed latency period 61, the present invention is not limited to such implementations. It is only required that the host 50 and memory controller 70 hold the same fixed latency period 61.

For example, only the host 50 may generate a fixed latency period 61. In such implementations, the fixed latency period 61 is generated based on the random number 53A only. The host 50 suitably transmits the fixed latency period 61 generated, instead of a random number exchange command, to the memory controller 70. Conversely, only the memory controller 70 may generate a fixed latency period 61 and transmit the fixed latency period 61 generated to the host 50.

Alternatively, an initial value of the fixed latency period 61 may be pre-set in the host 50 and memory controller. Alternatively, an initial value of the fixed latency period 61 may be pre-set only in the host 50. In such implementations, upon startup, the host 50 may transmit the fixed latency period 61 to the memory controller 70.

Although the above embodiment describes implementations where the host 50 and memory controller 70 exchange random numbers before generating a fixed latency period 61, the present invention is not limited to such implementations. If the random number generators 53 and 34 are pseudo-random number generators using the same algorithm, the exchange of random numbers may be omitted. More specifically, each of the random number generators 53 and 34 updates its own random number at a predetermined time point, which means that they generate the same pseudo-random number. This eliminates the necessity for the host 50 and memory controller 70 to exchange random numbers, thereby improving the confidentiality of the fixed latency period 61. The time point at which the random number is updated may be, for example, the time where the read process based on a read command has been done a predetermined number of times, or the time at which the host 50 transmits a command for an update of the random number.

If random numbers used to generate a fixed latency period 61 or fixed latency period 61 are not exchanged between the host 50 and memory controller 70, this makes it still more difficult for a third party to identify the fixed latency period 61 or data relating to the fixed latency period 61, thereby making it still more difficult to fabricate a duplicate.

The use of pseudo-random numbers does not restrict the exchange of random numbers. For example, the random number generators 53 and 34 may use different algorithms to generate pseudo-random numbers. In this case, pseudo-random numbers generated by the random number generators 53 and 34 are exchanged.

Although the above embodiment describes implementation where the fixed latency period 61 is updated each time the fixed latency process is performed, the host 50 and memory controller 70 may not update the fixed latency period 61.

Further, part or all of each of the memory controllers 30 and 70 described in the above embodiments may be implemented as an integrated circuit (for example, LSI, system LSI etc.).

Further, some or all of the processes in the above embodiments may be implemented using hardware, or using software (i.e. operating system (OS) or middleware, or software implemented together with a certain library). Further, they may be implemented using a combination of software and hardware.

The term “unit” herein may include “circuitry,” which may be partly or entirely implemented by using either hardware or software, or both hardware and software.

Although embodiments of the present invention have been described, the above embodiments are merely examples used to carry out the present invention. Thus, the present invention is not limited to the embodiments illustrated above, and the above embodiments may be modified as necessary without departing from the spirit of the invention.

What is claimed is:

1. A memory controller accessing a semiconductor memory in response to a request from a host, the memory controller comprising:
a command decoder configured to extract an address in the semiconductor memory from a read command received from the host; and
an access controller configured to transmit, to the host, data in the semiconductor memory associated with the address at a time point decided based on a predetermined fixed latency period.

2. The memory controller according to claim 1, wherein:
the fixed latency period is a minimum latency with which the memory controller can respond to the read command,
the memory controller further comprises an address acquirer configured to acquire a latency-related designated address, which is an address in the semiconductor memory storing data to be transmitted with the minimum latency in response to the read command, and is identical with an address held by the host, and
the access controller includes:
a pre-acquirer configured to read the data for the latency-related designated address from the semiconductor memory and store it in a buffer;
a comparator configured to compare the address extracted from the read command to the latency-related designated address acquired by the address acquirer; and
a transmission controller configured to transmit, based on a result of the comparison by the comparator, the data stored in the buffer to the host at a time point at which the minimum latency ends.

3. The memory controller according to claim 2, wherein:
the address acquirer updates the latency-related designated address after the transmission controller transmits the data stored in the buffer to the host, and
the pre-acquirer reads data for the updated latency-related designated address from the semiconductor memory and updates the data stored in the buffer with the data for the updated latency-related designated address.

4. The memory controller according to claim 2, wherein, if the comparator has determined that the address extracted from the read command matches the latency-related designated address, the transmission controller transmits the data stored in the buffer to the host at the time point at which the minimum latency ends.

5. The memory controller according to claim 2, wherein, if the comparator has determined that the address included in the read command does not match the latency-related designated address, the transmission controller reads, from the semiconductor memory, data for the address extracted from the read command, and transmits the data read from the semiconductor memory.

6. The memory controller according to claim 2, wherein, if the comparator has determined that the address extracted from the read command matches the latency-related designated address, the transmission controller transmits the data stored in the buffer directly after completion of reception of the read command.

7. The memory controller according to claim 2, wherein, if the comparator has determined that the address extracted from the read command matches the latency-related designated address, the transmission controller transmits the data stored in the buffer subsequently to one busy signal and one ready signal.

8. The memory controller according to claim 2, wherein the address acquirer includes:
a random number generator configured to generate a random number to be used to generate the latency-related designated address; and
an address generator configured to use a predetermined algorithm to generate the latency-related designated address from the random number generated by the random number generator.

9. The memory controller according to claim 2, wherein the address acquirer acquires a latency-related designated address generated by the host.

10. The memory controller according to claim 1, further comprising:
a latency acquirer configured to acquire the fixed latency period, which is identical with a latency period held by the host,
wherein the access controller includes:
a read controller configured to instruct the semiconductor memory to read data for the address extracted from the read command; and
a transmission controller configured to decide a transmission time point at which transmission of the data for the address is initiated based on the fixed latency period such that an interval between a time point at which the memory controller receives the read command and the transmission time point is longer than a time required to read the data for the address from the semiconductor memory, and to transmit the data for the address to the host at the transmission time point that has been decided on.

11. The memory controller according to claim 10, wherein, if the transmission controller is informed by the semiconductor memory that the semiconductor memory is ready to output the data for the address included in the read command before completion of the fixed latency period starting from a predetermined time point, then, the transmission controller transmits the data for the address at a time of completion of the fixed latency period.

12. The memory controller according to claim 10, wherein the transmission controller conceals a busy signal transmitted before initiation of transmission of the data for the address.

13. The memory controller according to claim 12, wherein the transmission controller conceals at least one of a period for transmission of the busy signal and a value of the busy signal.

14. The memory controller according to claim 13, further comprising a random number generator configured to generate a random number,
wherein the transmission controller uses the random number generated by the random number generator to conceal at least one of the period for transmission of the busy signal and the value of the busy signal.

15. The memory controller according to claim 10, wherein the latency acquirer updates the fixed latency period if a predetermined condition is met.

16. The memory controller according to claim 15, wherein the latency acquirer updates the fixed latency period after the transmission controller has transmitted the data for the address.

17. The memory controller according to claim 10, further comprising a determinator configured to determine whether the data for the address is to be transmitted at the time point decided based on the fixed latency period or the data for the address is to be transmitted when it is possible for the read controller to read the data for the address.

18. The memory controller according to claim 10, wherein the latency acquirer includes:
a random number generator configured to generate a random number; and
a latency generator configured to use a predetermined algorithm to generate the fixed latency period from the random number generated by the random number generator.

19. The memory controller according to claim 10, wherein the latency acquirer acquires the fixed latency period generated by the host.

20. A memory system comprising:
a host;
a semiconductor memory; and
a memory controller configured to access the semiconductor memory in response to a request from the host,
wherein the memory controller includes:
a command decoder configured to extract an address in the semiconductor memory from a read command received from the host; and
a first access controller configured to transmit, to the host, data in the semiconductor memory associated with the address at a time point decided based on a predetermined fixed latency period, and
wherein the host includes a second access controller configured to transmit the read command to the memory controller and to receive the data for the address from the memory controller at a time point of completion of the fixed latency period starting from a time point at which the host transmitted the read command.

21. The memory system according to claim 20, wherein:
the fixed latency period is a minimum latency with which the memory controller can respond to the read command,
the memory controller further includes an address acquirer configured to acquire a latency-related designated address, which is an address in the semiconductor memory storing data to be transmitted with the minimum latency in response to the read command received from the host,
the first access controller includes:
a pre-acquirer configured to read the data for the latency-related designated address from the semiconductor memory and store it in a buffer;
a first comparator configured to compare the address included in the read command received from the host to the latency-related designated address acquired by the address acquirer,
a transmission controller configured to transmit, to the host, data stored in the buffer at a time point of completion of the minimum latency depending on a result of the comparison by the first comparator,
the host further includes:
a storage configured to store the latency-related designated address; and
a second comparator configured to compare the address included in the read command to the latency-related designated address stored in the storage before transmitting the read command to the memory controller, and
the second access controller receives the data stored in the buffer from the memory controller at the time point of completion of the minimum latency depending on a result of the comparison by the second comparator.

22. The memory system according to claim 21, wherein:
the second access controller updates the latency-related designated address before completion of a predetermined period starting at a time point at which it receives the data stored in the buffer from the memory controller,
the address acquirer updates the latency-related designated address before completion the predetermined period starting at a time point at which the first access controller transmits the data stored in the buffer to the host, and
the pre-acquirer reads data for the updated latency-related designated address from the semiconductor memory and updates the data stored in the buffer with the data for the updated latency-related designated address.

23. The memory system according to claim 21, wherein:
the memory controller further includes a first random number generator configured to generate a first random number,
the host further includes a second random number generator configured to generate a second random number, and
each of the address acquirer and the access controller uses a predetermined algorithm to generate the latency-related designated address from the first and second random numbers.

24. The memory system according to claim 20, wherein:
the memory controller further includes a latency acquirer configured to acquire the fixed latency period;
the first access controller includes:
a read controller configured to instruct the semiconductor memory to read the data for the address based on the address included in the read command received from the host; and
a transmission controller configured to decide a transmission time point at which transmission of the data for the address is initiated based on the fixed latency period such that an interval between a time point at which the memory controller receives the read command from the host and the transmission time point is longer than a time required to read the data for the address from the semiconductor memory, and to transmit the data for the address to the host at the transmission time point that has been decided on,
the host includes a storage configured to store the fixed latency period, and
the second access controller receives the data for the address from the memory controller at the time point decided based on the fixed latency period.

25. The memory system according to claim 24, wherein:
the second access controller updates the fixed latency period before completion of the predetermined period starting at a time point at which it receives the data for the address, and
the latency acquirer updates the fixed latency period before completion of the predetermined period starting at a time point at which it transmits the data for the address.

26. The memory system according to claim 24, wherein:
the memory controller further includes a first random number generator configured to generate a first random number,
the host further includes a second random number generator configured to generate a second random number, and
each of the latency acquirer and the second access controller uses a predetermined algorithm to generate the fixed latency period from the first and second random numbers.
